(19) United States
(12) Patent Application Publication
(10) Pub. No.: US 2026/0006549 A1
(43) Pub. Date: Jan. 1, 2026

(54) PERIODICALLY SWITCHING OFF GEOSYNCHRONOUS CELLS

(71) Applicant: QUALCOMM Incorporated, San Diego, CA (US)

(72) Inventors: Bharat SHRESTHA, San Diego, CA (US); Alberto RICO ALVARINO, San Diego, CA (US); Xiao Feng WANG, San Diego, CA (US); Ayan SENGUPTA, San Diego, CA (US); Amer CATOVIC, San Diego, CA (US); Stephen William EDGE, Escondido, CA (US); Haris ZISIMOPOULOS, London (GB)

(21) Appl. No.: 18/879,676

(22) PCT Filed: Jul. 31, 2023
(86) PCT No.: PCT/US2023/071370

§ 371 Date: Dec. 27, 2024

(30) Foreign Application Priority Data
Aug. 8, 2022 (GR) 20220100664

(51) Int. Cl. H04W 52/02; H04B 7/185; H04W 76/27; H04W 76/28; H04W 84/06

(52) U.S. Cl. CPC H04W 52/0216; H04B 7/18513; H04W 76/27; H04W 76/28; H04W 84/06

(57) ABSTRACT

Certain aspects of the present disclosure provide techniques for periodically switching off geosynchronous cells. A method that may be performed by a user equipment (UE) includes receiving an indication that a non-terrestrial network (NTN) cell will stop broadcasting synchronization signals (SS) during a period of time; and performing one or more actions during the period of time based on the indication.

### CROSS-REFERENCE TO RELATED APPLICATION

This application claims benefit of and priority to Greek Patent Application No. 20220100664, filed Aug. 8, 2022, which is herein incorporated by reference in its entirety for all applicable purposes.

### INTRODUCTION

Aspects of the present disclosure relate to wireless communications, and more particularly, to techniques for wireless communications with non-terrestrial network (NTN) cells.

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE). The method includes receiving an indication that a non-terrestrial network (NTN) cell will stop broadcasting synchronization signals (SS) during a period of time; and refraining from performing all IDLE mode tasks during the period of time.

Another aspect provides a method for wireless communications by a user equipment (UE). The method includes receiving an indication that a non-terrestrial network (NTN) cell will stop broadcasting synchronization signals (SS) during a period of time; and in response to failing to detect a cell signal during a paging occasion (PO) during the period of time, refraining from performing a cell search during the period of time.

Yet another aspect provides a method for wireless communications by a network entity. The method includes transmitting an indication that an NTN cell will stop broadcasting SS during a period of time; and ceasing transmissions in the NTN cell during the period of time based on the indication.

Yet another aspect provides an apparatus configured for wireless communications at a user equipment (UE). The apparatus includes one or more memories; and one or more processors coupled with the one or more memories and configured to cause the UE to: receive an indication that a non-terrestrial network (NTN) cell will stop broadcasting synchronization signals (SS) during a period of time; and refrain from performing all IDLE mode tasks during the period of time.

Yet another aspect provides an apparatus configured for wireless communications at a user equipment (UE). The apparatus includes one or more memories; and one or more processors coupled with the one or more memories and configured to cause the UE to: receive an indication that a non-terrestrial network (NTN) cell will stop broadcasting synchronization signals (SS) during a period of time; and in response to failing to detect a cell signal during a paging occasion (PO) during the period of time, refrain from performing a cell search during the period of time.

Yet another aspect provides an apparatus configured for wireless communications at a network entity. The apparatus includes one or more memories; and one or more processors coupled with the one or more memories and configured to cause the network entity to: transmit an indication that an NTN cell will stop broadcasting SS during a period of time; and cease one or more transmissions in the NTN cell during the period of time based on the indication.

Yet another aspect provides a method for wireless communications by a user equipment (UE). The method includes receiving an indication that a non-terrestrial network (NTN) cell will stop broadcasting synchronization signals (SS) during a period of time; and performing one or more actions during the period of time based on the indication.

Yet another aspect provides a method for wireless communications by a network entity. The method includes transmitting an indication that an NTN cell will stop broadcasting SS during a period of time; and performing one or more actions during the period of time based on the indication.

Yet another aspect provides an apparatus for wireless communications at a user equipment (UE). The apparatus includes one or more memories; and one or more processors coupled with the one or more memories and configured to cause the UE to: receive an indication that a non-terrestrial network (NTN) cell will stop broadcasting synchronization signals (SS) during a period of time; and perform one or more actions during the period of time based on the indication.

Yet another aspect provides an apparatus for wireless communications at a network entity. The apparatus includes one or more memories; and one or more processors coupled with the one or more memories and configured to cause the network entity to: transmit an indication that an NTN cell will stop broadcasting SS during a period of time; and perform one or more actions during the period of time based on the indication.

Yet another aspect provides a non-transitory computer-readable medium comprising computer-executable instructions that, when executed by one or more processors of a user equipment (UE), cause the UE to perform a method of wireless communications. The method includes receiving an indication that a non-terrestrial network (NTN) cell will stop broadcasting synchronization signals (SS) during a period of time; and performing one or more actions during the period of time based on the indication.

Yet another aspect provides a non-transitory computer-readable medium comprising computer-executable instructions that, when executed by one or more processors of a network entity, cause the network entity to perform a method of wireless communications. The method includes transmitting an indication that an NTN cell will stop broadcasting SS during a period of time; and performing one or more actions during the period of time based on the indication.

Yet another aspect provides an apparatus for wireless communications. The apparatus includes means for receiving an indication that a non-terrestrial network (NTN) cell will stop broadcasting synchronization signals (SS) during a period of time; and means for performing one or more actions during the period of time based on the indication.

Yet another aspect provides an apparatus for wireless communications. The apparatus includes means for transmitting an indication that an NTN cell will stop broadcasting SS during a period of time; and means for performing one or more actions during the period of time based on the indication.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 is a diagram illustrating an example wireless communication network having a non-terrestrial network entity.

FIG. 6 is a diagram illustrating an example of discontinuous coverage of a non-terrestrial network.

FIG. 7 depicts an example timeline of operations by a BS supporting a cell that is switched off and served by the cell, according to aspects of the present disclosure.

FIG. 8 is a call flow diagram illustrating example signaling for periodically switching off geosynchronous cells.

FIG. 9 depicts a method for wireless communications, according to one aspect.

FIG. 10 depicts a method for wireless communications, according to one aspect.

FIG. 11 depicts a method for wireless communications, according to one aspect.

FIG. 12 depicts a method for wireless communications, according to one aspect.

FIG. 13 depicts a method for wireless communications, according to one aspect.

FIG. 14 depicts aspects of an example communications device.

FIG. 15 depicts aspects of an example communications device.

### DETAILED DESCRIPTION

Aspects of the present disclosure provide apparatuses, methods, processing systems, and computer-readable mediums for periodically switching off (also referred to herein as “turning off”) non-terrestrial network (NTN) cells.

In cellular networks, a network energy efficiency mechanism can be used to save network resources during off hours. For example, in a terrestrial network (e.g., LTE, NR), network entities (e.g., central units (CUs)) may share coverage information and decide which cells (i.e., coverage areas of cellular networks that can be uniquely identified from a cell identification that is broadcast over the coverage areas from a cellular access point) to turn off (e.g., cease broadcasting the cell identification or other cell signals) and which cells to keep active. Turning off a cell may both reduce energy consumed by a network entity supporting the cell and make radio frequency spectrum available for other uses. In certain cases, an NTN may provide discontinuous radio coverage to a UE, for example, some NTNs (such as low Earth orbit (LEO) systems or medium earth orbit (MEO) systems) may have one or more revisit times (which may also be known as response times or coverage gaps) in certain geographical areas. The revisit time may be the duration between consecutive viewings (or coverages) of a given location for an NTN. As an example, a satellite revisit time (or coverage gap) for a location could be 10 to 40 minutes, depending on the number of satellites deployed. A UE may be unreachable by a wireless network (such as a core network) during a revisit time. If a cell is turned off, then a UE may have the option to reselect to other cells using, for example, measurements, barring, and/or handover techniques. A UE served by an NTN cell may be notified that the cell is being turned off shortly before a revisit time begins for a satellite supporting the NTN cell, and the UE may maintain service by reselecting to another cell during the satellite revisit time and/or conserve power by not searching for the NTN cell during the satellite revisit time.

However, in cases where a UE is in coverage of a cell (e.g., an NTN cell) served by a geosynchronous orbit (GSO) satellite (also referred to as a geosynchronous (GEO) cell, a geosynchronous orbit (GSO) cell, or a geosynchronous satellite orbit cell) or a non-GEO (NGSO) cell, especially in remote areas (e.g., desert, ocean, and the like), there may not be any other cells which the UE can reselect if the GEO cell or non-GEO cell is turned off. In the example where the UEs are in remote areas, if a GEO cell is turned off, then UEs served by the GEO cell that are in the remote areas may search unsuccessfully for another cell. Unsuccessful searching causes UEs to have increased power consumption. Additionally or alternatively, if the network (e.g., the radio access network) has communications to send to a UE served by the turned-off GEO cell, the network may report the UE is unreachable to the originator of the communications. In a different example where there are no UEs to be served by a GEO cell, a GSO satellite maintaining the GEO cell in an active state has increased energy consumption, and radio frequency (RF) spectrum used by the GEO cell is not available for other uses in the geographical area of the GEO cell.

In aspects of the present disclosure, non-terrestrial network cells, including GEO cells, are periodically turned off while UEs served or potentially served by those cells are kept informed of the periods during which the cells will be turned off. The provided techniques may also cause paging performed by the network to be deferred when the network has communications to send to a UE served by a turned-off NTN cell, instead of the network reporting (e.g., to an originator of the communications) the UE is unreachable. In aspects of the present disclosure, a UE that is informed that an NTN cell serving the UE will be turned off (e.g., the UE obtains an indication that the NTN cell will stop broadcasting synchronization signals) for a period refrains from performing (e.g., does not perform or defers performing) a cell search or IDLE mode tasks (e.g., measuring reference signals of the serving cell) during the period. Alternatively, the UE may attempt to detect synchronization signals (SS) transmitted by the cell during the period, and, upon failing to detect the SS (e.g., because the signal strength of the SS is too low for the UE to detect or because the SS were not transmitted by the cell), the UE may refrain from starting a cell search and may instead listen for SS and pages during a next paging opportunity (PO) for the UE. If the UE fails to detect a SS from the cell during a PO that the UE expects the cell to be turned on, the UE may start a cell search and/or declare a no cell available state in response to failing to detect SS from the cell.

The provided techniques enable an NTN cell (e.g., a GEO cell) to be switched off during periods when UEs served by the cell do not expect to communicate with the cell (e.g., all of the UEs are not performing user calls or other communications), enabling savings of power in both satellites and UEs and savings of RF spectrum.

Similarly in other scenarios (e.g., low Earth orbit (LEO) satellites, medium orbit earth (MEO) satellites, or GEO satellites), it may not be desirable for a satellite to transmit in all beams of the satellite continuously. For example, in instances where a beam is unloaded (e.g., provides service to few or no UEs), causing the satellite to cease transmitting broadcast signals may be more efficient from a power or bandwidth perspective than the satellite transmitting the broadcast signals. Additionally or alternatively, due to power limitation, a satellite may not be able to transmit at full power in all beams simultaneously. According to one or more examples, a discontinuous cell turn off mechanism can be used to indicate to a UE that broadcast channels for a cell may not be transmitted during a time period. In some instances, synchronization signal blocks (SSBs) are not broadcast for a cell, which may prevent a UE from receiving other broadcast channels from the cell. In other instances, the SSB is broadcast but other broadcast channels (e.g., system information blocks (SIBs) or channel state information reference signals (CSI-RSs)) are not transmitted in the cell during a cell turn off duration. In this case, the SSB may also indicate whether the other broadcast channels are transmitted or not.

According to one example, activation of discontinuous (e.g., repeating at regular or irregular intervals) cell turn off duration can also depend on the geographical location of the cell being discontinuously turned off, for example, activation may be longer in duration or shorter in duration in remote areas. Activation of discontinuous cell turn off duration can also depend on a traffic pattern, for example, activation may be longer in duration during off hours or around midnight local time.

### Introduction to Wireless Communication Networks

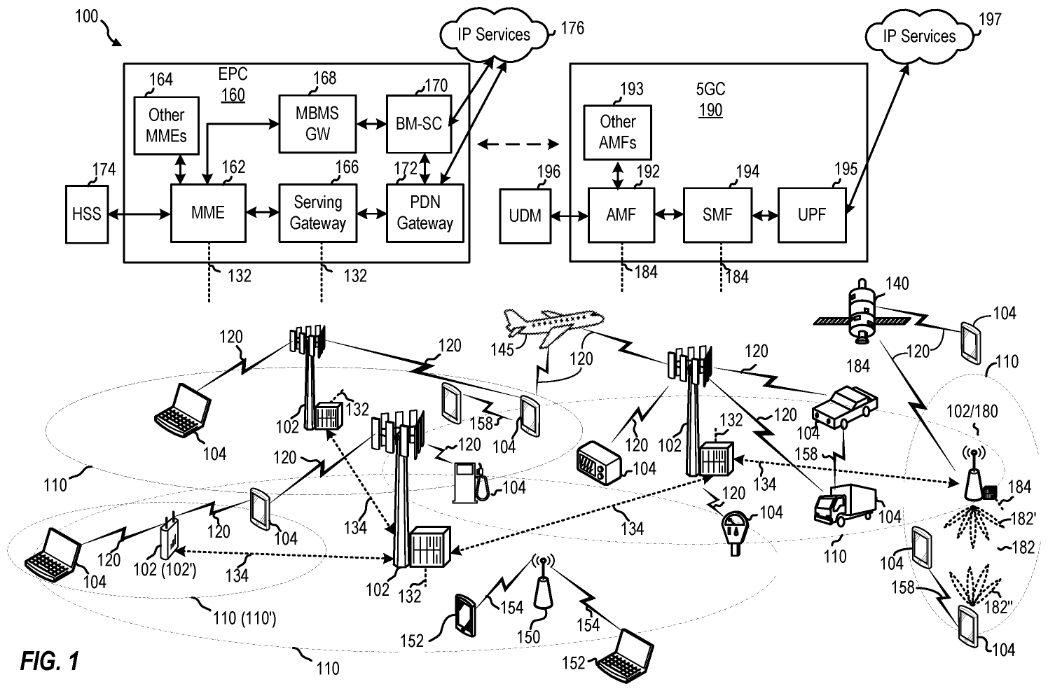

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

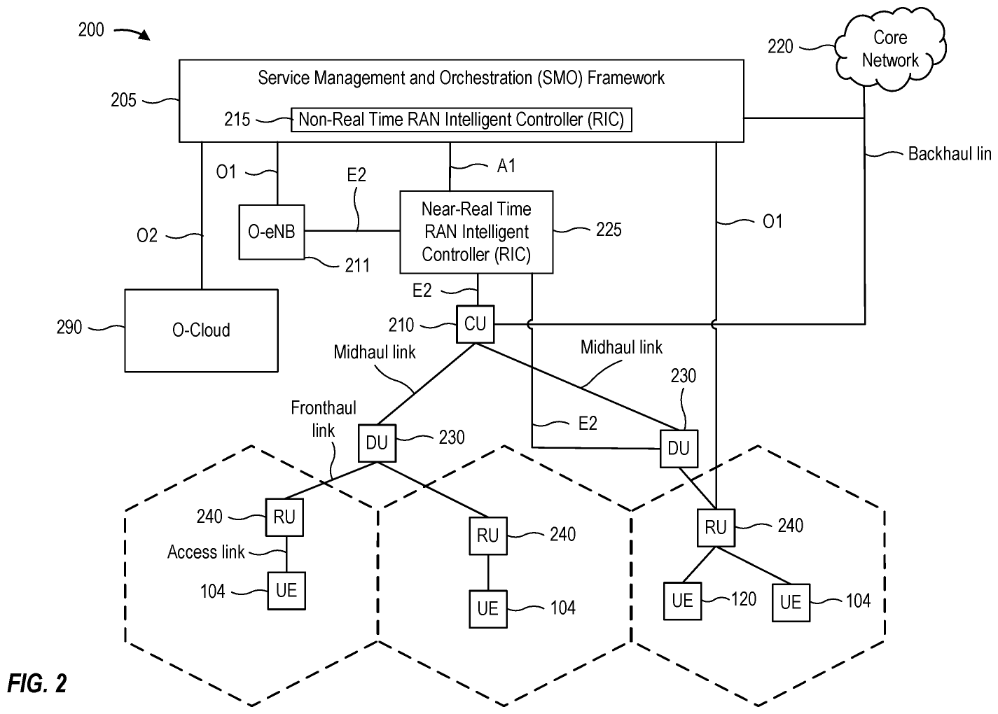

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240, and Near-RT RICs 225. In some implementations, the SMO Framework 205 can communicate with a hardware aspect of a 4G RAN, such as an open eNB (O-eNB) 211, via an O1 interface. Additionally or alternatively, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

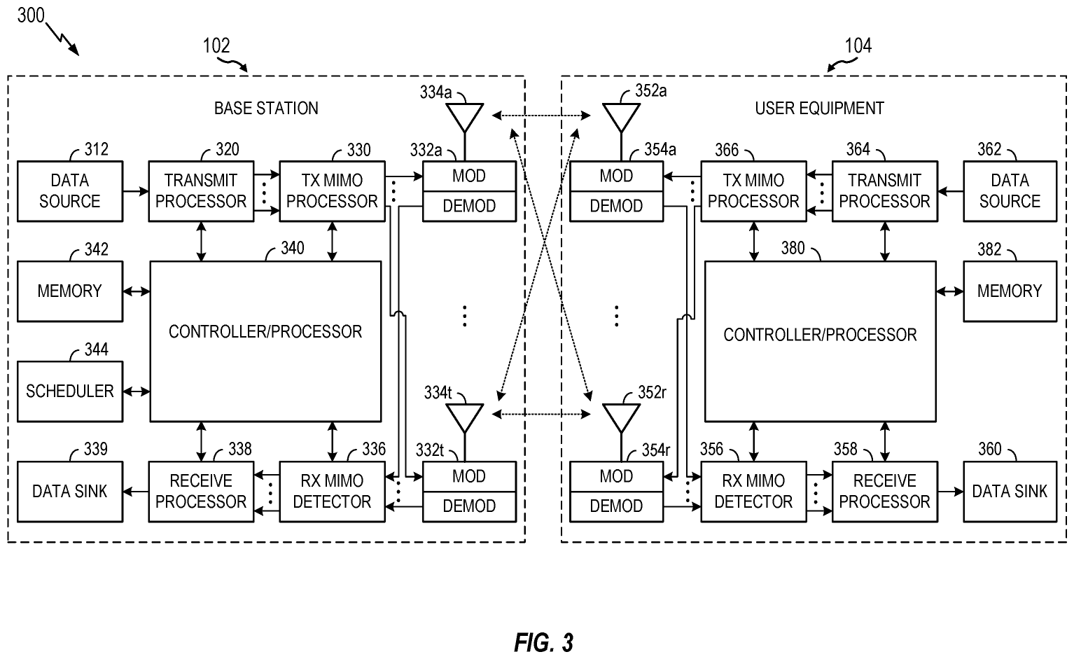

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

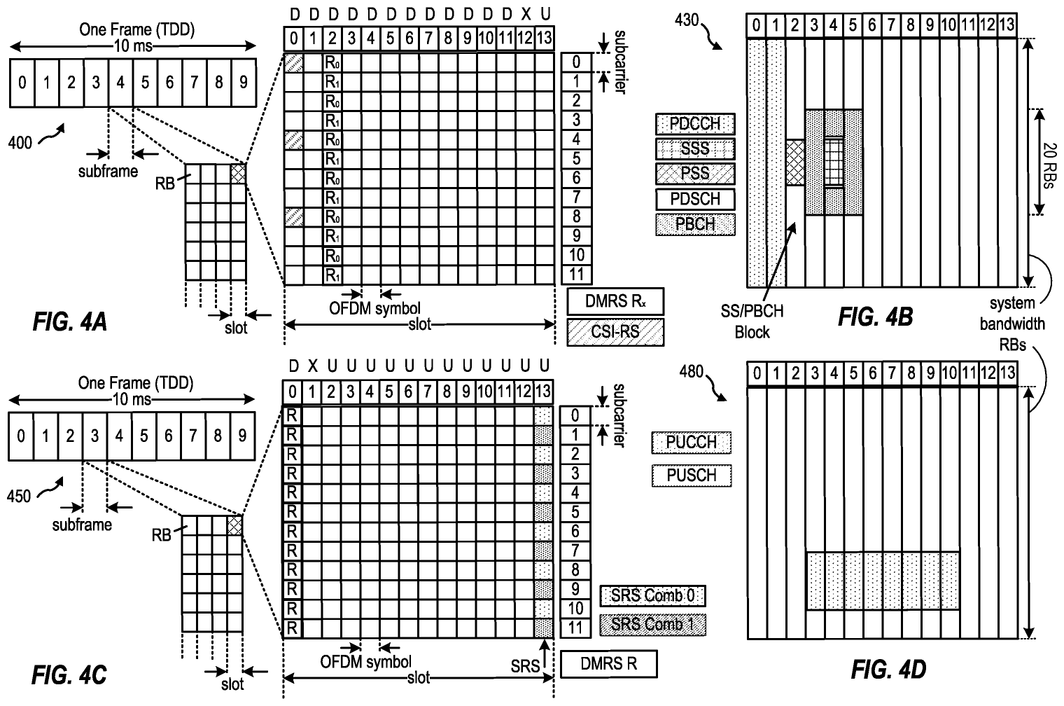

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally or alternatively be used to carry a buffer status report (BSR), a power headroom report (PHR), and/or UCI.

### Example Non-Terrestrial Network

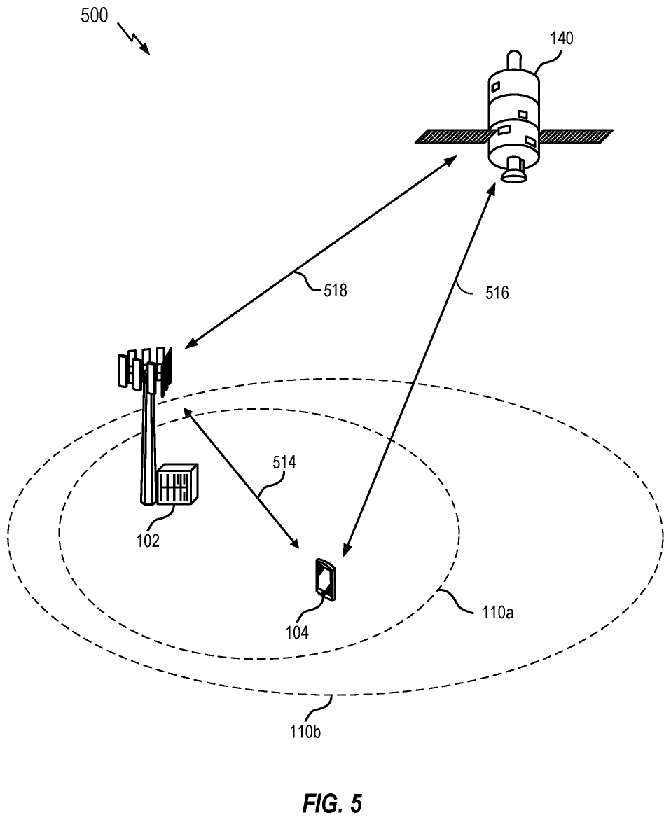

FIG. 5 illustrates an example of a wireless communications network 500 including a non-terrestrial network (NTN) entity 140 (which may be generally referred to as NTN 140), in which aspects of the present disclosure may be practiced. In some examples, the wireless communications network 500 may implement aspects of the wireless communication network 100. For example, the wireless communications network 500 may include BS 102, UE 104, and the non-terrestrial network entity 140, such as a satellite. BS 102 may serve a coverage area (also referred to herein as a cell) 110a in cases of a terrestrial network, and non-terrestrial network entity 140 may serve the coverage area 110b in cases of a non-terrestrial network (NTN). Some NTNs may employ airborne platforms (e.g., a balloon or unmanned aerial vehicle (UAV), also referred to as a drone) and/or spaceborne platforms (e.g., a satellite).

The non-terrestrial network entity 140 may communicate with the BS 102 and UE 104 as part of wireless communications in an NTN. In cases of a terrestrial network, the UE 104 may communicate with the BS 102 over a communication link 514. In the case of NTN wireless communications, the non-terrestrial network entity 140 may be a serving cell for the UE 104 via a communication link 516. In certain aspects, the non-terrestrial network entity 140 may act as a relay (or a remote radio head) for the BS 102 and the UE 104. For example, the BS 102 may communicate with the non-terrestrial network entity 140 via a communication link 518, and the non-terrestrial network entity may relay signaling between the BS 102 and UE 104 via the communication links 516, 518.

In certain cases, an NTN may provide discontinuous radio coverage to a UE, for example, due to the orbit of NTN satellites. For example, some NTNs (such as a low Earth orbit (LEO) systems or medium earth orbit (MEO) systems) may have one or more revisit times (which may also be known as the response time or coverage gap) in certain geographical areas. The revisit time may be the duration between consecutive viewings (or coverage areas) of a given location for an NTN. As an example, the satellite revisit time (or coverage gap) could be 10 to 40 minutes depending on the number of satellites deployed. The UE may be unreachable by the wireless network (such as the core network) during a revisit time.

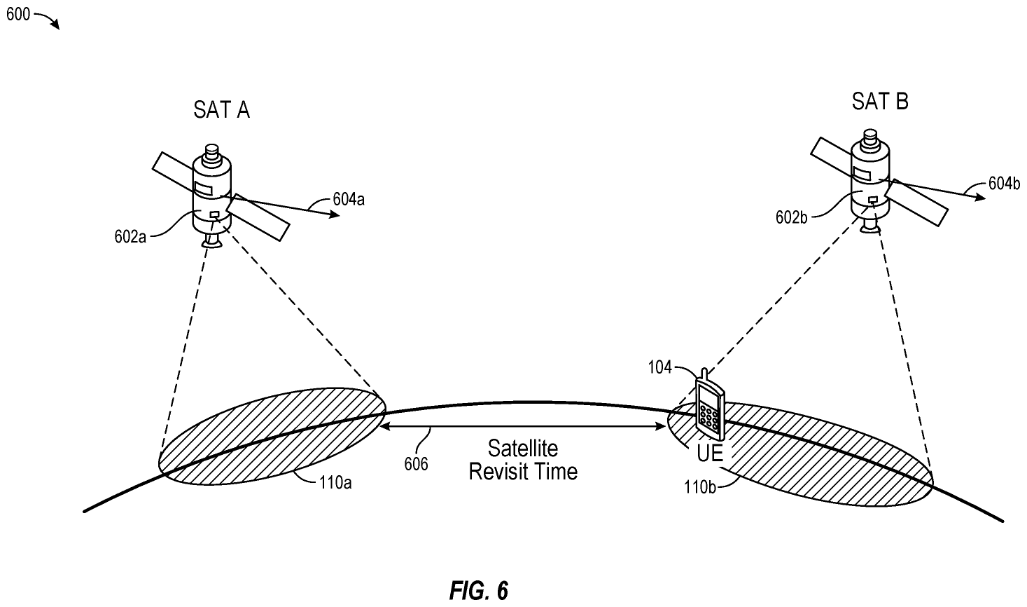

FIG. 6 is a diagram illustrating an example NTN 600 having a revisit time 606 between two satellites 602a and 602b. As shown, the UE 104 may be on the edge of the coverage area 110b of the second satellite 602b. The revisit time 606 may provide a coverage gap between the coverage areas 110a and 110b of the satellites 602a and 602b. As the satellites 602a and 602b orbit generally in the respective directions 604a and 604b, the coverage areas 110a and 110b as well as the revisit time 606 pass over the UE 104, such that the UE 104 may experience discontinuous coverage with the NTN 600. As an example, when a UE (e.g., the UE 104) is in a coverage area (e.g., the coverage areas 110a or 110b) of an NTN, the UE may be considered to be in an in-coverage state with the NTN, where the UE can communicate with the NTN. When the UE is in the coverage gap (e.g., the revisit time 606), the UE may be considered to be in an out-of-coverage state with the NTN for a certain duration (e.g., the revisit time), where the UE cannot communicate with the NTN. In some cases, the UE may be considered to be in an in-coverage state with the NTN when the NTN is able to be communicated with by the UE, whereas the UE may be considered to be in an out-of-coverage state with the NTN when the NTN is not able to be communicated with by the UE.

In some cellular networks, a network energy efficiency mechanism can be used to save network resources during off hours. For example, in a terrestrial network (e.g., LTE or NR), network entities (e.g., central units (CUs)) may share coverage information and decide which cells (i.e., coverage areas of cellular networks that can be uniquely identified from a cell identification that is broadcast over the coverage areas from a cellular access point) to turn off (e.g., cease broadcasting the cell identification or other cell signals) and which cells to keep active. If a cell is turned off, then a UE may have the option to reselect to other cells using, for example, measurements, barring, and/or handover techniques.

However, in cases where a UE is in coverage of a cell (e.g., an NTN cell) served by a GSO satellite (i.e., a GEO cell or a GSO cell), especially in remote areas (e.g., desert, ocean, and the like), there may not be any other cells which the UE can reselect if the GEO cell is turned off. Of course, in populated areas, such as cities, a UE would avoid reselecting to the GEO cell in the first place. Therefore, it is likely that most UEs that have selected to a GEO cell are in a remote area, where the UEs may have few or no other cells to which the UEs can reselect. According to one or more example, if there are no UEs served by a GEO cell that need to be in RRC_CONNECTED state, then a GSO satellite maintaining the GEO cell in an active state has increased energy consumption, and RF spectrum used by the GEO cell is not available for other uses in the geographical area of the GEO cell.

If a GEO cell is turned off, then UEs served by the GEO cell that are in remote areas may search unsuccessfully for another cell. Unsuccessful searching causes the UEs to have increased power consumption. Additionally or alternatively, if the network (e.g., the radio access network) has communications to send to a UE served by the turned-off GEO cell, the network may report the UE is unreachable to the originator of the communications.

Accordingly, it is desirable to develop techniques and apparatus for periodically switching off a geosynchronous cell while saving power and supporting paging UEs for mobile terminated (MT) calls.

### Aspects Related to Periodically Switching Off Geosynchronous Cells

Aspects of the present disclosure provide techniques and apparatus for periodically switching off geosynchronous cells. The provided techniques enable power saving for both geosynchronous orbit (GSO) satellites and UEs served by the GSO satellites while supporting paging of the UEs for MT calls.

In aspects of the present disclosure, a cell (e.g., a GEO cell) that switches off stops broadcasting synchronization signals (SS) or other broadcast signals. According to aspects of the present disclosure, a cell that will switch off may provide one or more indications that the cell will stop broadcasting SS.

According to aspects of the present disclosure, a GEO cell can broadcast in one or more system information blocks (SIBs) indications that the GEO cell will stop broadcasting SS. In some NTN cells, the serving cell can broadcast a SystemInformationBlockType32 (SIB32) providing the serving satellite and neighbor satellite information, including the cell start time. Broadcast of a SIB32 by an NTN cell indicates that the satellite supporting the cell supports discontinuous coverage and when a UE should wake up to find the satellite coverage, after current satellite coverage has stopped. The serving NTN cell also broadcasts, in a SystemInformationBlockType3 (SIB3), a parameter that indicates a time (t-service) to inform served UEs when the current cell coverage will be stopped. However, this t-service parameter may not be supported for some GEO cells.

In aspects of the present disclosure, a GEO cell may broadcast a t-service time in SIB3 and a satellite ID (of the satellite serving the GEO cell) in SIB31. The GEO cell may also broadcast the service cell satellite ID alone or both the serving cell satellite ID and two-line element (TLE) ephemeris data of the satellite serving the GEO cell in SIB32. The GEO cell may further broadcast the cell start time in SIB32. The cell start time may be provided in an IE named t-ServiceStart-r17. Providing the t-service time, satellite ID, and cell start time enables served UEs to know when the satellite serving the GEO cell will be switched off and switched back on.

According to aspects of the present disclosure, during the off time of a GEO cell (e.g., the GEO cell start time minus the immediately previous GEO cell stop time), a UE that was being served by the GEO cell before the off time may not perform any IDLE mode tasks. For example, the UE may refrain (e.g., not perform or defer performing until a later time) from listening for pages addressed to the UE during a paging occasion, or the UE may refrain from transmitting a physical random access channel (PRACH) to the GEO cell when the UE attempts to start a call (e.g., when a user of the UE attempts to start a call or access a network resource) while the UE is refraining from performing IDLE mode tasks.

In aspects of the present disclosure, during the off time of a GEO cell, a UE that was being served by the GEO cell before the off time may still perform one or more IDLE mode tasks. However, if the UE finds no serving cell signal (e.g., the UE is unable to receive a synchronization signal from the GEO cell) during a paging occasion (PO), the UE stops detecting for PDCCHs from the GEO cell, and waits until a next PO before performing one or more additional IDLE mode tasks.

In some NTN cells (e.g., GSO cells and non-GSO (NGSO) cells), a UE that receives a t-service time in a SIB3 performs intra-frequency, inter-frequency, and/or inter-radio access technology (inter-RAT) measurements of RS (e.g., of other cells) before the time indicated by the t-service time regardless of whether the serving cell fulfills criteria for performing those measurements (e.g., Sᵣₓₗₑᵥ>S_{IntraSearchP} and S_{qual}>S_{IntraSearchQ}, or Sᵣₓₗₑᵥ>S_{nonIntraSearchP} and S_{qual}>S_{nonIntraSearchQ}), though the exact time to start measurements before t-service may be determined by the UE. The UE may perform measurements of higher priority inter-frequencies or inter-RAT frequencies regardless of the remaining service time of the serving cell. Performing these measurements before the time indicated by the t-service parameter enables the UE to be prepared to handover to another cell at any time, which is desirable for NTN cells due to the possibility of the UE suddenly leaving the coverage area of an NTN cell due to the orbital movement of a satellite serving the NTN cell.

According to aspects of the present disclosure, a UE that receives from a serving cell a t-service time in a SIB3 and a t-ServiceStart-r17 IE in a SIB32 may determine whether to perform intra-frequency, inter-frequency, and/or inter-RAT measurements before the time indicated by the t-service parameter based on whether the serving cell is a GSO cell or an NGSO cell and other measurement rules. For example, a UE may determine not to perform intra-frequency, inter-frequency, and/or inter-RAT measurements before the time indicated by the t-service parameter based on the serving cell being a GSO cell.

In aspects of the present disclosure, a GEO cell can be treated similarly to a fixed terrestrial network cell, as the coverage area of the GEO cell does not change. In such a case, if a cell is going to be turned off, it would be desirable for a UE to obtain an indication of the ON/OFF periodicity of the cell or times when the cell is going to be off and for how long.

According to aspects of the present disclosure, information on ON/OFF periodicity of a cell or times when the cell is going to be off and for how long can be indicated to a UE via system information (e.g., sent to the UE in a SIB), a unicast radio resource control (RRC) message, or a non-access stratum (NAS) message.

In aspects of the present disclosure, during a cell OFF period (i.e., when a cell has switched off), a UE may keep the access stratum (AS) configuration that the UE had during a preceding cell ON period, may continue all of the running timers that the UE had started before the cell OFF period, and may not perform any IDLE mode tasks.

According to aspects of the present disclosure, during a cell OFF period, a UE may perform one or more IDLE mode tasks (such as periodic measurement of RS of higher priority frequencies and/or cells), but if no serving cell signal is detected during a paging occasion (PO), then the UE may try to detect a serving cell signal again in the next PO without starting a cell search procedure. That is, when the UE fails to detect a signal (e.g., synchronization signals) from the cell, the UE may not trigger measurements or a cell reselection procedure.

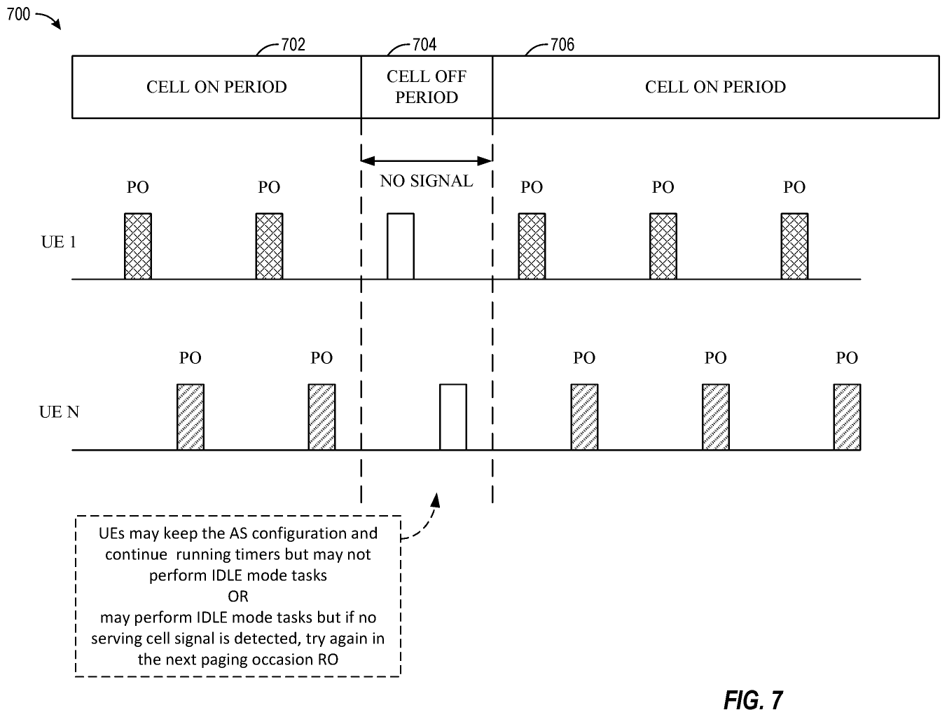

FIG. 7 depicts an example timeline 700 of operations by a network entity (e.g., BS 102 or satellite 140) supporting a cell (e.g., a GEO cell) that is switched off and UEs (e.g., UE 104) served by the cell, according to aspects of the present disclosure. As illustrated, the cell is on during ON periods 702 and 706. The cell is switched off during the OFF period 704, and does not transmit any signals during the OFF period. Each UE served by the cell is configured to listen for pages during paging occasions (POs) configured for that UE. As previously described, each of the UEs may perform no IDLE mode activities during the cell OFF period, as symbolized by the illustrated POs during the OFF period not being shaded. Alternatively, each of the UEs may attempt to detect SS transmitted by the cell during the OFF period, and, upon failing to detect the SS, each UE may refrain from starting a cell search and may instead listen for SS and pages during the next PO for the UE. If a UE fails to detect a SS from the cell during one of the ON periods 702 and 706, that UE may start a cell search and/or declare a no cell available state in response to failing to detect SS from the cell.

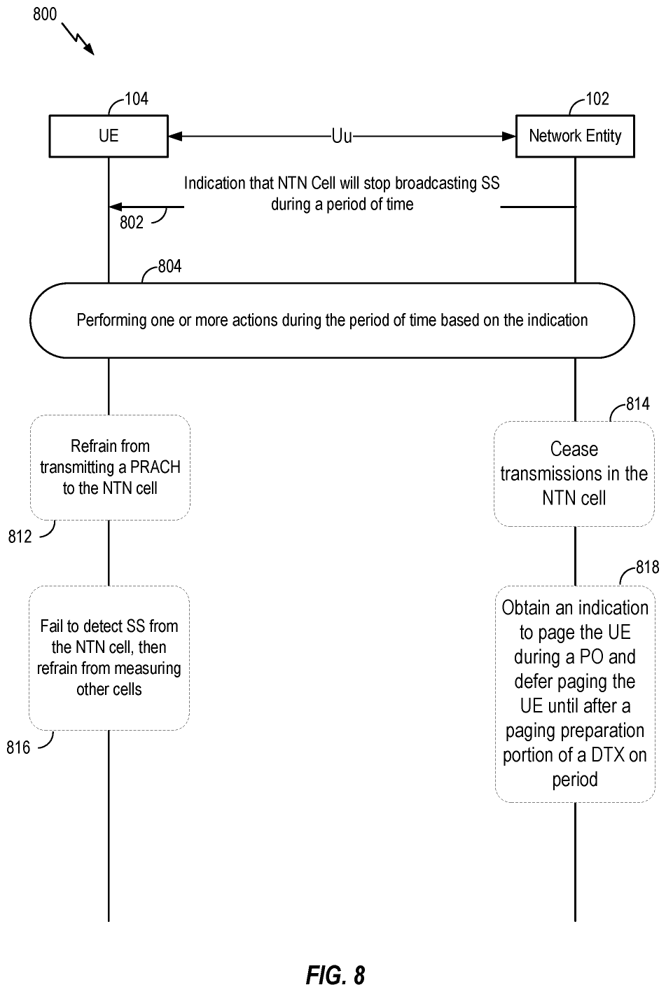

FIG. 8 depicts an example call flow diagram 800 for periodically switching off geosynchronous cells, according to aspects of the present disclosure. In this example, a network entity 102, which may be a BS or a node of a disaggregated base station, may wirelessly communicate with a UE 104 (e.g., via a Uu interface).

At 802, the network entity transmits to the UE an indication that a non-terrestrial network (NTN) cell will stop broadcasting synchronization signals (SS) during a period of time. The indication may, for example, be information regarding a discontinuous transmission (DTX) cycle of the NTN cell. Such a DTX cycle may be cell-specific, that is, the DTX cycle may apply to one NTN cell serviced by a satellite while other NTN cells supported by the satellite have other DTX cycles or do not have a DTX cycle.

At 804, the UE performs one or more actions during the period of time based on the indication. For example, the UE may refrain from communicating with the NTN cell, such as by transmitting a physical random access channel (PRACH), as shown at 812, or powering-on a receiver to attempt to receive SS or pages from the NTN cell. In another example, the UE may fail to detect SS (e.g., signal strength of the SS may be too low for the UE to be able to detect the SS, the SS may not be transmitted, or receiver(s) of the UE may be tuned to another frequency range for communicating with other cell(s)) from the NTN cell and then refrain from measuring other cells (e.g., in preparation for a handover to the other cells), as shown at 816. Also at 804, the network entity performs one or more actions during the period of time based on the indication. For example, the network entity may cease all transmissions (e.g., SS, SIBs, pages, and the like) in the cell as shown at 814. In another example, the network entity may obtain an indication to page the UE during a PO and defer paging the UE until after a paging preparation portion of a DTX on period, as shown at 818.

Those of skill in the art will appreciate that the call flow depicted in FIG. 8 is an example, and other signaling flows may be employed to periodically switch off geosynchronous cells. While the example signaling flow in FIG. 8 is described with specific timing for certain signaling to facilitate understanding, aspects of the present disclosure may also be applied to other timing arrangements for the signaling.

According to aspects of the present disclosure, a cell-specific DTX cycle may be used by a cell. The DTX cycle may have some similarities to a discontinuous reception (DRX) cycle assigned to a UE. Information regarding a DTX cycle for a cell may be provided to all UEs served by the cell. Providing the information as proposed herein may be an example of the network entity transmitting an indication that an NTN cell will stop broadcasting SS during a period of time, as shown at 802 in diagram 800 of FIG. 8. The information may tell the UEs about the ON and OFF cycle periods of the cell. The DTX may apply only to one cell supported by a network entity and thus be cell-specific, while other cells supported by the network entity do not have a DTX cycle or have other DTX cycles.

In aspects of the present disclosure, the information regarding a DTX cycle may include parameters such as: a starting offset (that may be named dtxOffset) that indicates the system frame number (SFN) within a hyper system frame in which DTX starts for the cell, a DTX cycle length (that may be named dtxPagingCycle) that indicates the length of time (which may be in numbers hyper system frames) between the start of each DTX cycle, and a DTX off period (that may be named dtxOff) that indicates the length of each OFF period.

According to aspects of the present disclosure, a DTX off period may begin in a hyper system frame where the hyper system frame number (H-SFN) modulo (DTX cycle length) is zero.

In aspects of the present disclosure, a network entity may change a DTX cycle for a cell, and the BS operating the cell may transmit information to served UEs regarding the change to the DTX cycle. Transmitting the information to served UEs regarding the change to the DTX cycle as proposed herein may be an example of the network entity transmitting an indication that an NTN cell will stop broadcasting SS during a period of time, as shown at 802 in diagram 800 of FIG. 8.

According to aspects of the present disclosure, a network entity may be restricted to only changing a DTX cycle of a cell during an ON period of the cell.

In aspects of the present disclosure, during a DTX ON period of a cell, DTX parameters may be updated in a similar way as any other static cell specific parameters using an SI change procedure. However, there can be UEs in power saving mode (e.g., using PSM and/or enhanced DRX (eDRX)) that may miss a page announcing the SI change. Those UEs may wake up during a DTX ON period of a previous DTX cycle of the cell and fail to detect the cell because the updated DTX cycle causes the cell to be off at these times.

According to aspects of the present disclosure, a network entity (e.g., a BS) may configure PSM and/or eDRX for a UE such that a paging window for the UE does not fall during a DTX OFF period for a cell, enabling the UE to be paged when the DTX cycle is changed.

In aspects of the present disclosure, a default OFF period or maximum OFF period may be configured at a UE such that the UE tries to find the cell at least for the default OFF period or the maximum OFF period before the UE declares a no cell available state.

According to aspects of the present disclosure, the length of a DTX OFF period may be a fixed value in a wireless communications specification. In such a case, a cell operating with DTX may only broadcast a DTX cycle length and a starting offset. Broadcasting the DTX cycle length and starting offset as proposed herein may be an example of a network entity transmitting an indication that an NTN cell will stop broadcasting SS during a period of time, as shown at 802 in diagram 800 of FIG. 8.

In aspects of the present disclosure, a default duty cycle for DTX may be defined in a wireless communications standard. For example, a default duty cycle may be 1/10 of the DTX cycle, such that the cell is active for 1/10 of each DTX cycle. In the example, if the DTX cycle is 1 hyper system frame (i.e., 1024 system frames), then the OFF period for such a DTX cycle is 922 system frames, and the ON period is 102 system frames.

According to aspects of the present disclosure, a cell may provide assistance information regarding a neighbor cell's DTX cycle to a UE.

In some networks, when a UE searches for a GEO cell when the UE is moving from a terrestrial network (TN) coverage area or a LEO or GEO coverage area, the UE may not have information on whether the GEO cell is using DTX.

In aspects of the present disclosure, a serving cell may provide an indication to a UE regarding whether a neighboring GEO cell uses DTX in the inter-frequency list or neighbor cell list that the serving cell provides to the UE.

According to aspects of the present disclosure, during an RRC release procedure, when a UE is redirected to a GEO cell, information on a DTX cycle (e.g., DTX starting offset, DTX cycle length, DTX period, DTX duty cycle, and/or the like) of the GEO cell may also be provided to the UE. Providing the information on the DTX cycle during an RRC release procedure as proposed herein may be an example of the network entity transmitting an indication that an NTN cell will stop broadcasting SS during a period of time, as shown at 802 in diagram 800 of FIG. 8. The UE may refrain from transmitting a PRACH transmission to the GEO cell during a DTX OFF period of the cell. Refraining from transmitting a PRACH in a cell using DTX during a DTX OFF period of the cell as proposed herein may be an example of a UE performing one or more actions during the period of time based on the indication, as shown at 804 in diagram 800 of FIG. 8.

In aspects of the present disclosure, when configuring a UE to measure (e.g., measure RS in preparation for a handover) a GEO cell or a frequency used by a GEO cell, information on a DTX cycle (e.g., DTX starting offset, DTX cycle length, DTX period, DTX duty cycle, and/or the like) of the GEO cell can also be provided to the UE using a unicast RRC message. Provision of the information on the DTX cycle in a unicast RRC message as proposed herein may be an example of a network entity transmitting an indication that an NTN cell will stop broadcasting SS during a period of time, as shown at 802 in diagram 800 of FIG. 8.

According to aspects of the present disclosure, when measuring a cell that is using DTX, a UE may perform the measurements based on DTX information for the cell, so that the UE may perform the measurements of the cell in a power efficient way.

In aspects of the present disclosure, if a cell is using DTX and a last known location of a UE is in that cell, then a network entity (e.g., a central unit (CU)) may defer paging the UE while the cell is in a DTX OFF period. The network entity may wait until a paging occasion for the UE occurs during a DTX ON period for the cell before sending a command to page the UE to another network entity (e.g., a BS or a satellite). Deferring paging of a UE in a cell using DTX during a DTX OFF period of the cell as proposed herein may be an example of the network entity performing one or more actions during the period of time based on the indication, as shown at 804 in diagram 800 of FIG. 8.

According to aspects of the present disclosure, when a paging occasion for a UE falls in the beginning of a DTX ON period for a cell using DTX, a network entity may defer paging the UE until the next paging occasion for the UE, because the UE may be preparing for paging (e.g., reading essential SIBs) at the beginning of the DTX ON period and unable to receive a page.

In aspects of the present disclosure, a paging preparation gap between a DTX OFF period and a DTX ON period may be defined during which paging of a UE may be deferred and the UE may read essential SIBs. After the paging preparation gap has passed, a UE may be ready for paging (e.g., able to receive pages).

### Example Operations of a User Equipment

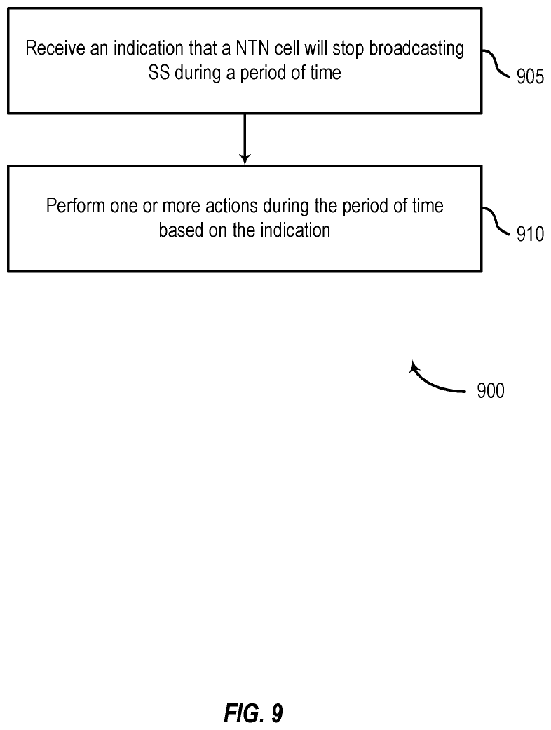

FIG. 9 shows an example of a method 900 for wireless communications by a UE, such as a UE 104 of FIGS. 1 and 3.

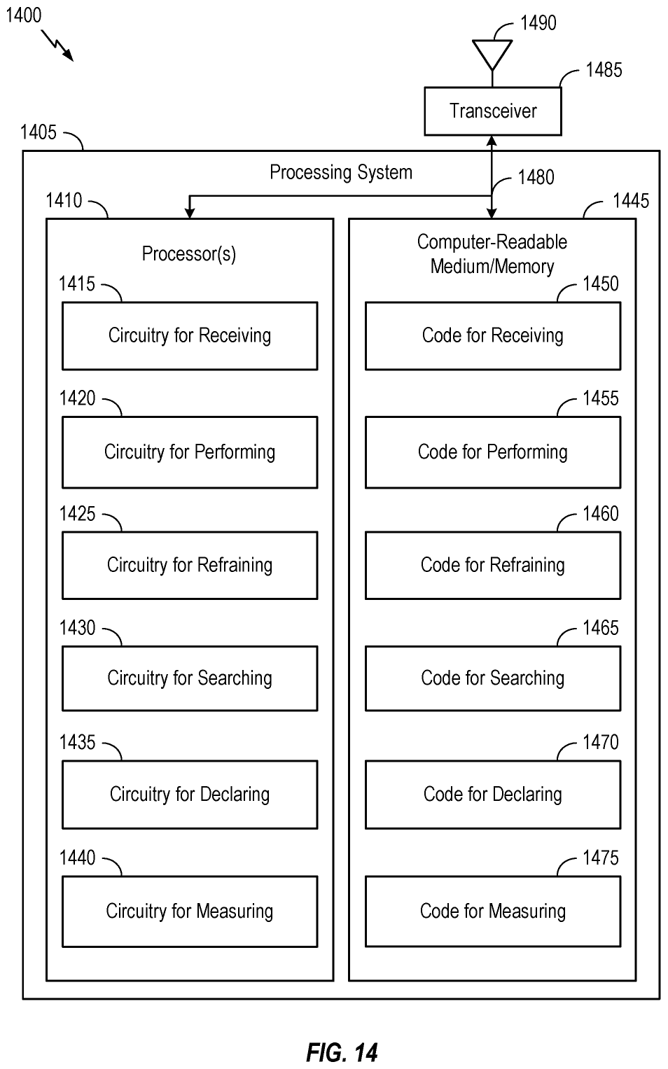

Method 900 begins at step 905 with receiving an indication that a NTN cell will stop broadcasting SS during a period of time. In some cases, the operations of this step refer to, or may be performed by, circuitry for receiving and/or code for receiving as described with reference to FIG. 14.

Method 900 then proceeds to step 910 with performing one or more actions during the period of time based on the indication. In some cases, the operations of this step refer to, or may be performed by, circuitry for performing and/or code for performing as described with reference to FIG. 14.

In some aspects, the one or more actions comprise refraining from communicating with the NTN cell.

In some aspects, the NTN cell comprises a GSO cell; and receiving the indication comprises: receiving a start time and end time of the period of time in a first SIB; and receiving an identifier of the GSO cell in a second SIB.

In some aspects, the method 900 further includes performing one or more IDLE mode tasks during the period of time. In some cases, the operations of this step refer to, or may be performed by, circuitry for performing and/or code for performing as described with reference to FIG. 14.

In some aspects, the method 900 further includes, upon failing to detect a signal from the cell, refraining from performing at least one of intra-frequency, inter-frequency, or inter-RAT measurements, based on the NTN cell comprising the GSO cell. In some cases, the operations of this step refer to, or may be performed by, circuitry for refraining and/or code for refraining as described with reference to FIG. 14.

In some aspects, the one or more actions comprise refraining from performing all IDLE mode tasks during the period of time.

In some aspects, the one or more actions comprise: attempting to detect a cell signal during a PO during the period of time; and in response to failing to detect the cell signal during the PO, refraining from performing a cell search during the period of time.

In some aspects, receiving the indication comprises receiving information regarding a cell-specific DTX cycle of the NTN cell.

In some aspects, the information comprises: a start offset of the DTX cycle; a length of the DTX cycle; and a DTX off period.

In some aspects, the information comprises: a start time of a DTX off period of the DTX cycle; and an end time of the DTX off period.

In some aspects, the indication is received in a SIB. In some aspects, the method 900 further includes receiving a paging indication indicating a change to the SIB; and receiving the SIB in response to the paging indication. In some cases, the operations of this step refer to, or may be performed by, circuitry for receiving and/or code for receiving as described with reference to FIG. 14.

In some aspects, the method 900 further includes, after the period of time, searching for the cell for a default OFF period. In some cases, the operations of this step refer to, or may be performed by, circuitry for searching and/or code for searching as described with reference to FIG. 14.

In some aspects, the method 900 further includes declaring a no cell available state in response to failing to detect the cell during the default OFF period. In some cases, the operations of this step refer to, or may be performed by, circuitry for declaring and/or code for declaring as described with reference to FIG. 14.

In some aspects, the default OFF period is defined in a communications specification.

In some aspects, the indication comprises a length of a DTX cycle of the NTN cell; the default OFF period is determined as a fraction of the DTX cycle; and the fraction is defined in a communications specification.

In some aspects, the indication is received from another cell.

In some aspects, the indication is included in an inter-frequency list or a neighbor cell list.

In some aspects, the indication is received in a RRC release procedure.

In some aspects, the method 900 further includes measuring the NTN cell based on the indication. In some cases, the operations of this step refer to, or may be performed by, circuitry for measuring and/or code for measuring as described with reference to FIG. 14.

In some aspects, the indication comprises at least one of a start time for the period of time, a duration of the period of time or a stop time for the period of time.

In some aspects, the NTN cell is supported by a satellite, wherein the satellite is in one of a GSO, a LEO, or a MEO.

In one aspect, method 900, or any aspect related to it, may be performed by an apparatus, such as apparatus 1400 of FIG. 14, which includes various components operable, configured, or adapted to perform the method 900. Apparatus 1400 is described below in further detail.

Note that FIG. 9 is just one example of a method, and other methods including fewer, additional, or alternative steps are possible consistent with this disclosure.

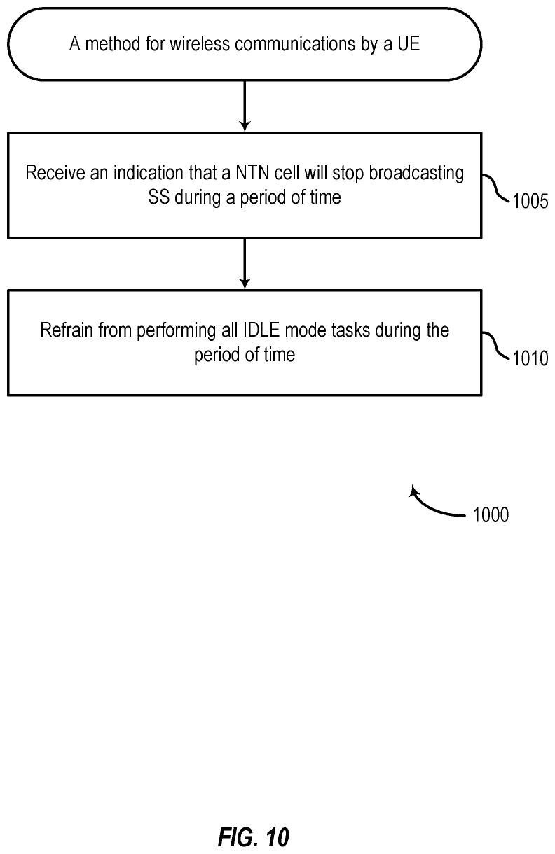

FIG. 10 shows an example of a method 1000 for wireless communications by a UE, such as a UE 104 of FIGS. 1 and 3.

Method 1000 begins at step 1005 with receiving an indication that a NTN cell will stop broadcasting SS during a period of time. In some cases, the operations of this step refer to, or may be performed by, circuitry for receiving and/or code for receiving as described with reference to FIG. 14.

Method 1000 then proceeds to step 1010 with refraining from performing all IDLE mode tasks during the period of time. In some cases, the operations of this step refer to, or may be performed by, circuitry for performing and/or code for performing as described with reference to FIG. 14.

In some aspects, the method 1000 further includes refraining from communicating with the NTN cell.

In some aspects, the NTN cell comprises a GSO cell; and receiving the indication comprises: receiving a start time and end time of the period of time in a first SIB; and receiving an identifier of the GSO cell in a second SIB.

In some aspects, receiving the indication comprises receiving information regarding a cell-specific DTX cycle of the NTN cell.

In some aspects, the information comprises: a start offset of the DTX cycle; a length of the DTX cycle; and a DTX off period.

In some aspects, the information comprises: a start time of a DTX off period of the DTX cycle; and an end time of the DTX off period.

In some aspects, the indication is received in a SIB. In some aspects, the method 1000 further includes receiving a paging indication indicating a change to the SIB; and receiving the SIB in response to the paging indication. In some cases, the operations of this step refer to, or may be performed by, circuitry for receiving and/or code for receiving as described with reference to FIG. 14.

In some aspects, the method 1000 further includes, after the period of time, searching for the cell for a default OFF period. In some cases, the operations of this step refer to, or may be performed by, circuitry for searching and/or code for searching as described with reference to FIG. 14.

In some aspects, the method 1000 further includes declaring a no cell available state in response to failing to detect the cell during the default OFF period. In some cases, the operations of this step refer to, or may be performed by, circuitry for declaring and/or code for declaring as described with reference to FIG. 14.

In some aspects, the default OFF period is defined in a communications specification.

In some aspects, the indication comprises a length of a DTX cycle of the NTN cell; the default OFF period is determined as a fraction of the DTX cycle; and the fraction is defined in a communications specification.

In some aspects, the indication is received from another cell.

In some aspects, the indication is included in an inter-frequency list or a neighbor cell list.

In some aspects, the indication is received in a RRC release procedure.

In some aspects, the method 1000 further includes measuring the NTN cell based on the indication. In some cases, the operations of this step refer to, or may be performed by, circuitry for measuring and/or code for measuring as described with reference to FIG. 14.

In some aspects, the indication comprises at least one of a start time for the period of time, a duration of the period of time or a stop time for the period of time.

In some aspects, the NTN cell is supported by a satellite, wherein the satellite is in one of a GSO, a LEO, or a MEO.

In one aspect, method 1000, or any aspect related to it, may be performed by an apparatus, such as apparatus 1400 of FIG. 14, which includes various components operable, configured, or adapted to perform the method 1000. Apparatus 1400 is described below in further detail.

Note that FIG. 10 is just one example of a method, and other methods including fewer, additional, or alternative steps are possible consistent with this disclosure.

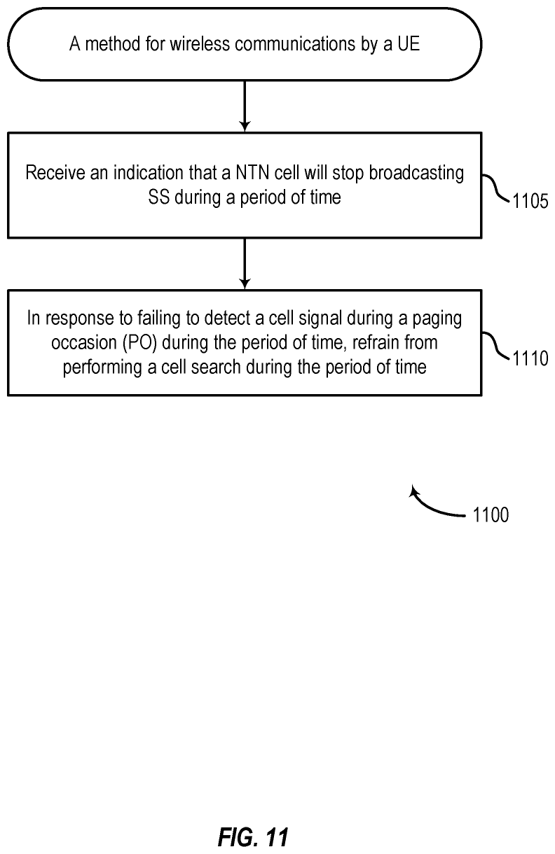

FIG. 11 shows an example of a method 1100 for wireless communications by a UE, such as a UE 104 of FIGS. 1 and 3.

Method 1100 begins at step 1105 with receiving an indication that a NTN cell will stop broadcasting SS during a period of time. In some cases, the operations of this step refer to, or may be performed by, circuitry for receiving and/or code for receiving as described with reference to FIG. 14.

Method 1100 then proceeds to step 1110 with, in response to failing to detect a cell signal during a paging occasion (PO) during the period of time, refraining from performing a cell search during the period of time. In some cases, the operations of this step refer to, or may be performed by, circuitry for performing and/or code for performing as described with reference to FIG. 14.

In some aspects, the one or more actions comprise refraining from communicating with the NTN cell.

In some aspects, the NTN cell comprises a GSO cell; and receiving the indication comprises: receiving a start time and end time of the period of time in a first SIB; and receiving an identifier of the GSO cell in a second SIB.

In some aspects, the method 1100 further includes performing one or more IDLE mode tasks during the period of time. In some cases, the operations of this step refer to, or may be performed by, circuitry for performing and/or code for performing as described with reference to FIG. 14.

In some aspects, the method 1100 further includes: performing one or more IDLE mode tasks during the period of time; and, upon failing to detect the cell signal, refraining from performing at least one of intra-frequency, inter-frequency, or inter-RAT measurements, of a Terrestrial network cell, the NTN cell, or a non-GSO (NGSO) cell. In some cases, the operations of this step refer to, or may be performed by, circuitry for refraining and/or code for refraining as described with reference to FIG. 14.

In some aspects, the method 1100 further includes: performing one or more IDLE mode tasks during the period of time; and attempting to detect the cell signal during the PO during the period of time.

In some aspects the method 1100 further includes performing cell search during the period of time at least based on arrival of uplink data.

In some aspects, receiving the indication comprises receiving information regarding a cell-specific DTX cycle of the NTN cell.

In some aspects, the information comprises: a start offset of the DTX cycle; a length of the DTX cycle; and a DTX off period.

In some aspects, the information comprises: a start time of a DTX off period of the DTX cycle; and an end time of the DTX off period.

In some aspects, the indication is received in a SIB. In some aspects, the method 1100 further includes receiving a paging indication indicating a change to the SIB; and receiving the SIB in response to the paging indication. In some cases, the operations of this step refer to, or may be performed by, circuitry for receiving and/or code for receiving as described with reference to FIG. 14.

In some aspects, the method 1100 further includes, after the period of time, searching for the cell for a default OFF period. In some cases, the operations of this step refer to, or may be performed by, circuitry for searching and/or code for searching as described with reference to FIG. 14.

In some aspects, the method 1100 further includes declaring a no cell available state in response to failing to detect the NTN cell during the default OFF period. In some cases, the operations of this step refer to, or may be performed by, circuitry for declaring and/or code for declaring as described with reference to FIG. 14.

In some aspects, the default OFF period is defined in a communications specification.

In some aspects, the indication comprises a length of a DTX cycle of the NTN cell; the default OFF period is determined as a fraction of the DTX cycle; and the fraction is defined in a communications specification.

In some aspects, the indication is received from another cell.

In some aspects, the indication is included in an inter-frequency list or a neighbor cell list.

In some aspects, the indication is received in a RRC release procedure.

In some aspects, the method 1100 further includes measuring the NTN cell based on the indication. In some cases, the operations of this step refer to, or may be performed by, circuitry for measuring and/or code for measuring as described with reference to FIG. 14.

In some aspects, the indication comprises at least one of a start time for the period of time, a duration of the period of time, or a stop time for the period of time.

In some aspects, the NTN cell is supported by a satellite, wherein the satellite is in one of a GSO, a LEO, or a MEO.

In some aspects, the method 1100 further includes performing periodic measurement of higher priority frequencies and/or cells while the UE is refraining from performing a cell search for the NTN cell. In some cases, the operations of this step refer to, or may be performed by, circuitry for performing and/or code for performing as described with reference to FIG. 14.

In one aspect, method 1100, or any aspect related to it, may be performed by an apparatus, such as apparatus 1400 of FIG. 14, which includes various components operable, configured, or adapted to perform the method 1100. Apparatus 1400 is described below in further detail.

Note that FIG. 11 is just one example of a method, and other methods including fewer, additional, or alternative steps are possible consistent with this disclosure.

### Example Operations of a Network Entity

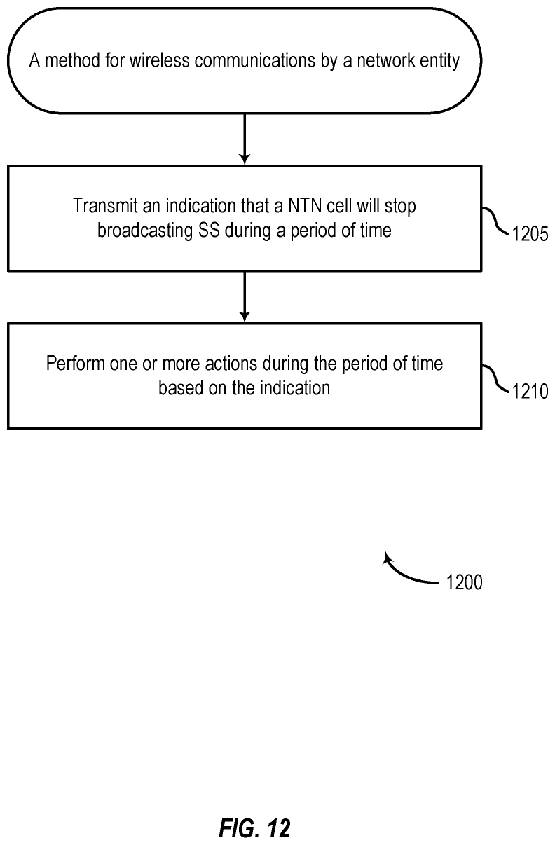

FIG. 12 shows an example of a method 1200 for wireless communications by a network entity, such as a BS 102 of FIGS. 1 and 3, or a disaggregated base station as discussed with respect to FIG. 2.

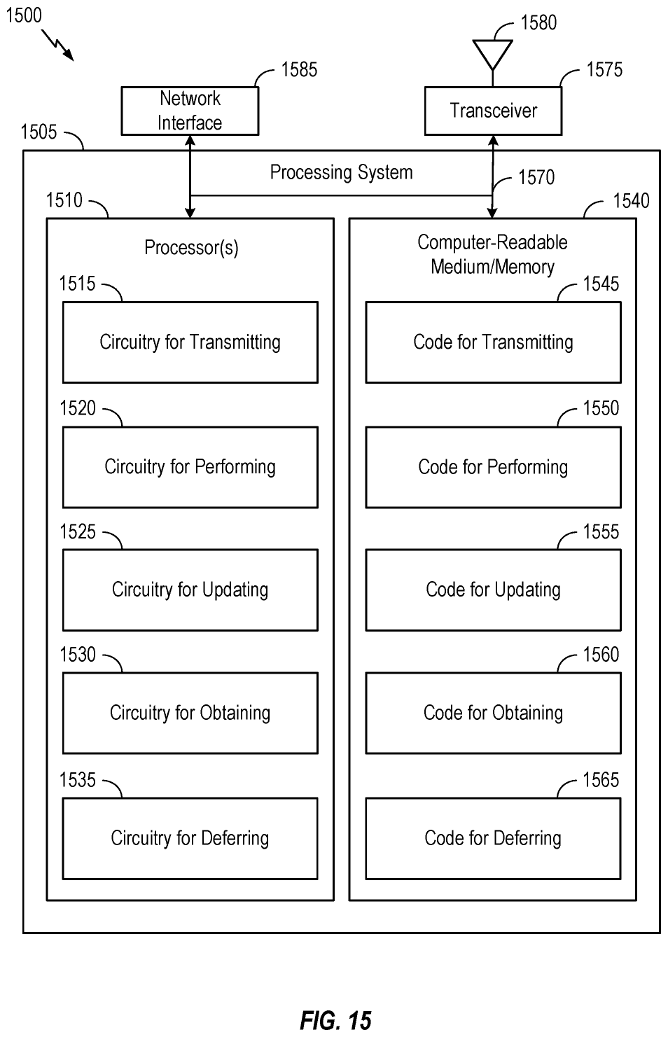

Method 1200 begins at step 1205 with transmitting an indication that a NTN cell will stop broadcasting SS during a period of time. In some cases, the operations of this step refer to, or may be performed by, circuitry for transmitting and/or code for transmitting as described with reference to FIG. 15.

Method 1200 then proceeds to step 1210 with performing one or more actions during the period of time based on the indication. In some cases, the operations of this step refer to, or may be performed by, circuitry for performing and/or code for performing as described with reference to FIG. 15.

In some aspects, the one or more actions comprise ceasing transmissions in the NTN cell.

In some aspects, the NTN cell comprises a GSO cell; and transmitting the indication comprises: transmitting a start time of the period of time in a first SIB; and transmitting an identifier of the GSO cell in a second SIB.

In some aspects, the indication comprises: a start offset of a DTX cycle; a length of the DTX cycle; and a length of a DTX off period of the DTX cycle.

In some aspects, the indication comprises: a start time of a DTX off period of a DTX cycle; and an end time of the DTX off period.

In some aspects, transmitting the indication comprises transmitting the indication in a SIB.

In some aspects, the method 1200 further includes transmitting a paging indication indicating a change to the SIB. In some cases, the operations of this step refer to, or may be performed by, circuitry for transmitting and/or code for transmitting as described with reference to FIG. 15.

In some aspects, transmitting the indication comprises transmitting information regarding a DTX cycle of the network entity, wherein the DTX cycle includes a DTX on period and a DTX off period.

In some aspects, the method 1200 further includes transmitting new information regarding a new DTX cycle of the network entity during the DTX on period, wherein the new DTX cycle includes a new DTX on period and a new DTX off period. In some cases, the operations of this step refer to, or may be performed by, circuitry for transmitting and/or code for transmitting as described with reference to FIG. 15.

In some aspects, the method 1200 further includes updating a PSM or an eDRX cycle of a UE so that a PO for the UE occurs during the new DTX on period. In some cases, the operations of this step refer to, or may be performed by, circuitry for updating and/or code for updating as described with reference to FIG. 15.

In some aspects, the information regarding the DTX cycle comprises a length of the DTX cycle of the network entity.

In some aspects, transmitting the indication comprises transmitting information regarding a DTX cycle of the network entity, wherein the DTX cycle includes a DTX on period and a DTX off period.

In some aspects, the method 1200 further includes obtaining an indication to page a UE during a PO during a paging preparation portion of the DTX on period. In some cases, the operations of this step refer to, or may be performed by, circuitry for obtaining and/or code for obtaining as described with reference to FIG. 15.

In some aspects, the method 1200 further includes deferring paging the UE until after the paging preparation portion of the DTX on period. In some cases, the operations of this step refer to, or may be performed by, circuitry for deferring and/or code for deferring as described with reference to FIG. 15.

In one aspect, method 1200, or any aspect related to it, may be performed by an apparatus, such as apparatus 1500 of FIG. 15, which includes various components operable, configured, or adapted to perform the method 1200. Apparatus 1500 is described below in further detail.

Note that FIG. 12 is just one example of a method, and other methods including fewer, additional, or alternative steps are possible consistent with this disclosure.

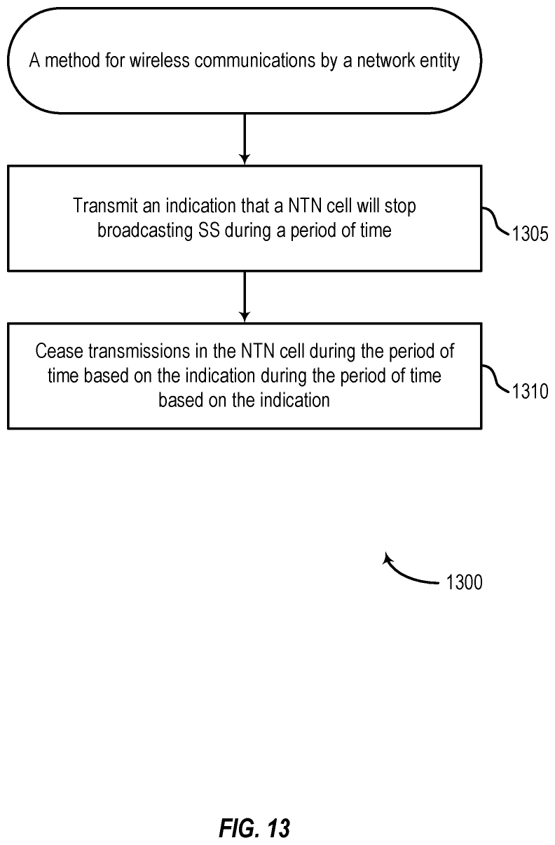

FIG. 13 shows an example of a method 1300 for wireless communications by a network entity, such as a BS 102 of FIGS. 1 and 3, or a disaggregated base station as discussed with respect to FIG. 2.

Method 1300 begins at step 1305 with transmitting an indication that a NTN cell will stop broadcasting SS during a period of time. In some cases, the operations of this step refer to, or may be performed by, circuitry for transmitting and/or code for transmitting as described with reference to FIG. 15.

Method 1300 then proceeds to step 1310 with ceasing transmissions in the NTN cell during the period of time based on the indication. In some cases, the operations of this step refer to, or may be performed by, circuitry for performing and/or code for performing as described with reference to FIG. 15.

In some aspects, the NTN cell comprises a GSO cell; and transmitting the indication comprises: transmitting a start time of the period of time in a first SIB; and transmitting an identifier of the GSO cell in a second SIB.

In some aspects, the indication comprises: a start offset of a DTX cycle; a length of the DTX cycle; and a length of a DTX off period of the DTX cycle.

In some aspects, the indication comprises: a start time of a DTX off period of a DTX cycle; and an end time of the DTX off period.

In some aspects, transmitting the indication comprises transmitting the indication in a SIB.

In some aspects, the method 1300 further includes transmitting a paging indication indicating a change to the SIB. In some cases, the operations of this step refer to, or may be performed by, circuitry for transmitting and/or code for transmitting as described with reference to FIG. 15.

In some aspects, transmitting the indication comprises transmitting information regarding a DTX cycle of the network entity, wherein the DTX cycle includes a DTX on period and a DTX off period.

In some aspects, the method 1300 further includes: transmitting new information regarding a new DTX cycle of the network entity during the DTX on period, wherein the new DTX cycle includes a new DTX on period and a new DTX off period. In some cases, the operations of this step refer to, or may be performed by, circuitry for transmitting and/or code for transmitting as described with reference to FIG. 15.

In some aspects, the method 1300 further includes updating a PSM or an eDRX cycle of a UE so that a PO for the UE occurs during the new DTX on period. In some cases, the operations of this step refer to, or may be performed by, circuitry for updating and/or code for updating as described with reference to FIG. 15.

In some aspects, the information regarding the DTX cycle comprises a length of the DTX cycle of the network entity.

In some aspects, transmitting the indication comprises transmitting information regarding a DTX cycle of the network entity, wherein the DTX cycle includes a DTX on period and a DTX off period.

In some aspects, the method 1300 further includes obtaining an indication to page a UE during a PO during a paging preparation portion of the DTX on period. In some cases, the operations of this step refer to, or may be performed by, circuitry for obtaining and/or code for obtaining as described with reference to FIG. 15.

In some aspects, the method 1300 further includes deferring paging the UE until after the paging preparation portion of the DTX on period. In some cases, the operations of this step refer to, or may be performed by, circuitry for deferring and/or code for deferring as described with reference to FIG. 15.

In one aspect, method 1300, or any aspect related to it, may be performed by an apparatus, such as apparatus 1500 of FIG. 15, which includes various components operable, configured, or adapted to perform the method 1300. Apparatus 1500 is described below in further detail.

Note that FIG. 13 is just one example of a method, and other methods including fewer, additional, or alternative steps are possible consistent with this disclosure.

### Example Communications Devices

FIG. 14 is a diagram illustrating an example of an implementation of code and circuitry for an apparatus 1400, in accordance with the present disclosure. The circuity may include processing circuitry and memory circuitry. In some aspects, apparatus 1400 is a user equipment, such as a UE 104 described above with respect to FIGS. 1 and 3, or a UE may include the apparatus 1400.

The apparatus 1400 includes a processing system 1405 coupled to the transceiver 1485 (e.g., a transmitter and/or a receiver). The transceiver 1485 is configured to transmit and receive signals for the apparatus 1400 via the antenna 1490, such as the various signals as described herein. The processing system 1405 may be configured to perform processing functions for the apparatus 1400, including processing signals received and/or to be transmitted by the apparatus 1400.

The processing system 1405 includes one or more processors (or processing circuitry) 1410. In various aspects, the one or more processors (or processing circuitry) 1410 may be representative of one or more of receive processor 358, transmit processor 364, TX MIMO processor 366, and/or controller/processor 380, as described with respect to FIG. 3. The one or more processors (or processing circuitry) 1410 are coupled to a computer-readable medium/memory (or memory circuitry) 1445 via a bus 1480. In certain aspects, the computer-readable medium/memory (or memory circuitry) 1445 is configured to store instructions (e.g., computer-executable code) that when executed by the one or more processors (or processing circuitry) 1410, cause the one or more processors (or processing circuitry) 1410 to perform the methods 900, 1000, or 1100 described with respect to FIGS. 9, 10, and 11, or any aspect related to them. Note that reference to a processor performing a function of apparatus 1400 may include one or more processors (or processing circuitry) 1410 performing that function of apparatus 1400.

In the depicted example, computer-readable medium/memory (or memory circuitry) 1445 stores code (e.g., executable instructions), such as code for receiving 1450, code for performing 1455, code for refraining 1460, code for searching 1465, code for declaring 1470, and code for measuring 1475. Processing of the code for receiving 1450, code for performing 1455, code for refraining 1460, code for searching 1465, code for declaring 1470, and code for measuring 1475 may cause the apparatus 1400 to perform the methods 900, 1000, or 1100 described with respect to FIGS. 9, 10, and 11, or any aspect related to them.

The one or more processors (or processing circuitry) 1410 include circuitry configured to implement (e.g., execute) the code stored in the computer-readable medium/memory (or memory circuitry) 1445, including circuitry such as circuitry for receiving 1415, circuitry for performing 1420, circuitry for refraining 1425, circuitry for searching 1430, circuitry for declaring 1435, and circuitry for measuring 1440. Processing with circuitry for receiving 1415, circuitry for performing 1420, circuitry for refraining 1425, circuitry for searching 1430, circuitry for declaring 1435, and circuitry for measuring 1440 may cause the apparatus 1400 to perform the methods 900, 1000, or 1100 described with respect to FIGS. 9, 10, and 11, or any aspect related to them. The one or more processors may be individually or collectively operable to transmit messages via a non-terrestrial network. The one or more processors are configured to individually or collectively cause the UE to perform one or more of the methods 900, 1000, or 1100 described with respect to FIGS. 9, 10, and 11, or any aspect related to them.

Various components of the apparatus 1400 may provide means for performing the methods 900, 1000, or 1100 described with respect to FIGS. 9, 10, and 11 or any aspect related to them. For example, means for transmitting, sending, or outputting for transmission may include transceivers 354 and/or antenna(s) 352 of the UE 104 illustrated in FIG. 3 and/or the transceiver 1485 and the antenna 1490 of the apparatus 1400 in FIG. 14. Means for receiving or obtaining may include transceivers 354 and/or antenna(s) 352 of the UE 104 illustrated in FIG. 3 and/or the transceiver 1485 and the antenna 1490 of the apparatus 1400 in FIG. 14.

FIG. 15 is a diagram illustrating an example of an implementation of code and circuitry for an apparatus 1500. The circuity may include processing circuitry and memory circuitry. In some aspects, the apparatus 1500 is a network entity, such as a BS 102 of FIGS. 1 and 3, or a disaggregated base station as discussed with respect to FIG. 2. In some aspects, the apparatus 1500 is included in a network entity.

The apparatus 1500 includes a processing system 1505 coupled to the transceiver 1575 (e.g., a transmitter and/or a receiver) and/or a network interface 1585. The transceiver 1575 is configured to transmit and receive signals for the apparatus 1500 via the antenna 1580, such as the various signals as described herein. The network interface 1585 is configured to obtain and send signals for the apparatus 1500 via communication link(s), such as a backhaul link, midhaul link, and/or fronthaul link as described herein, such as with respect to FIG. 2. The processing system 1505 may be configured to perform processing functions for the apparatus 1500, including processing signals received and/or to be transmitted by the apparatus 1500.

The processing system 1505 includes one or more processors (or processing circuitry) 1510. In various aspects, one or more processors (or processing circuitry) 1510 may be representative of one or more of receive processor 338, transmit processor 320, TX MIMO processor 330, and/or controller/processor 340, as described with respect to FIG. 3. The one or more processors (or processing circuitry) 1510 are coupled to a computer-readable medium/memory (or memory circuitry) 1540 via a bus 1570. In certain aspects, the computer-readable medium/memory (or memory circuitry) 1540 is configured to store instructions (e.g., computer-executable code) that when executed by the one or more processors (or processing circuitry) 1510, cause the one or more processors (or processing circuitry) 1510 to perform the methods 1200 or 1300 described with respect to FIGS. 12 and 13, or any aspect related to them. Note that reference to a processor of apparatus 1500 performing a function may include one or more processors (or processing circuitry) 1510 of apparatus 1500 performing that function.

In the depicted example, the computer-readable medium/memory (or memory circuitry) 1540 stores code (e.g., executable instructions), such as code for transmitting 1545, code for performing 1550, code for updating 1555, code for obtaining 1560, and code for deferring 1565. Processing of the code for transmitting 1545, code for performing 1550, code for updating 1555, code for obtaining 1560, and code for deferring 1565 may cause the apparatus 1500 to perform the methods 1200 or 1300 described with respect to FIGS. 12 and 13, or any aspect related to them.

The one or more processors (or processing circuitry) 1510 include circuitry configured to implement (e.g., execute) the code stored in the computer-readable medium/memory (or memory circuitry) 1540, including circuitry such as circuitry for transmitting 1515, circuitry for performing 1520, circuitry for updating 1525, circuitry for obtaining 1530, and circuitry for deferring 1535. Processing with circuitry for transmitting 1515, circuitry for performing 1520, circuitry for updating 1525, circuitry for obtaining 1530, and circuitry for deferring 1535 may cause the apparatus 1500 to perform the methods 1200 or 1300 as described with respect to FIGS. 12 and 13, or any aspect related to them. The one or more processors may be individually or collectively operable to transmit messages via a non-terrestrial network. The one or more processors are configured to individually or collectively cause the network entity to perform one or more of the methods 1200 or 1300 as described with respect to FIGS. 12 and 13, or any aspect related to them.

Various components of the apparatus 1500 may provide means for performing the methods 1200 or 1300 as described with respect to FIGS. 12 and 13, or any aspect related to it. Means for transmitting, sending, or outputting for transmission may include transceivers 332 and/or antenna(s) 334 of the BS 122 illustrated in FIG. 3 and/or the transceiver 1575 and the antenna 1580 of the apparatus 1500 in FIG. 15. Means for receiving or obtaining may include transceivers 332 and/or antenna(s) 334 of the BS 102 illustrated in FIG. 3 and/or the transceiver 1575 and the antenna 1580 of the apparatus 1500 in FIG. 15.

### Example Clauses

Implementation examples are described in the following numbered clauses:

Clause 1: A method for wireless communications by a UE, comprising: receiving an indication that a NTN cell will stop broadcasting SS during a period of time; and performing one or more actions during the period of time based on the indication.

Clause 2: The method of Clause 1, wherein the one or more actions comprise refraining from communicating with the NTN cell.

Clause 3: The method of any one of Clauses 1 and 2, wherein: the NTN cell comprises a GSO cell; and receiving the indication comprises: receiving a start time of the period of time in a first SIB; and receiving an end time of the period of time and an identifier of the GSO cell in a second SIB.

Clause 4: The method of Clause 3, further comprising: performing one or more IDLE mode tasks during the period of time; and upon failing to detect a signal from the cell, refraining from performing at least one of intra-frequency, inter-frequency, or inter-RAT measurements, of a Terrestrial network cell, the NTN cell comprising the GSO cell, or a non-GSO (NGSO) cell.

Clause 5: The method of any one of Clauses 1-4, wherein the one or more actions comprise refraining from performing all IDLE mode tasks during the period of time.

Clause 6: The method of any one of Clauses 1-5, wherein the one or more actions comprise: performing one or more IDLE mode tasks and attempting to detect a cell signal during a PO during the period of time; and in response to failing to detect the cell signal during the PO, refraining from performing a cell search during the period of time.

Clause 7: The method of any one of Clauses 1-6, wherein the one or more actions comprise performing cell search during the period of time at least based on arrival of uplink data.

Clause 8: The method of any one of Clauses 1-7, wherein receiving the indication comprises receiving information regarding a cell-specific DTX cycle of the NTN cell.

Clause 9: The method of Clause 8, wherein the information comprises: a start offset of the DTX cycle; a length of the DTX cycle; and a DTX off period of the DTX cycle.

Clause 10: The method of Clause 8, wherein the information comprises: a start time of a DTX off period of the DTX cycle; and an end time of the DTX off period.

Clause 11: The method of any one of Clauses 1-10, wherein the indication is received in a SIB, and the method further comprises: receiving a paging indication indicating a change to the SIB; and receiving the SIB in response to the paging indication.

Clause 12: The method of any one of Clauses 1-11, further comprising: after the period of time, searching for the cell for a default OFF period; and declaring a no cell available state in response to failing to detect the cell during the default OFF period

Clause 13: The method of Clause 12, wherein the default OFF period is defined in a communications specification.

Clause 14: The method of Clause 12, wherein: the indication comprises a length of a DTX cycle of the NTN cell; the default OFF period is determined as a fraction of the DTX cycle; and the fraction is defined in a communications specification.

Clause 15: The method of any one of Clauses 1-14, wherein the indication is received from another cell.

Clause 16: The method of Clause 15, wherein the indication is included in an inter-frequency list or a neighbor cell list.

Clause 17: The method of Clause 15, wherein the indication is received in a RRC release procedure.

Clause 18: The method of Clause 15, further comprising: measuring the NTN cell based on the indication.

Clause 19: The method of any one of Clauses 1-18, wherein the indication comprises at least one of a start time for the period of time, a duration of the period of time or a stop time for the period of time.

Clause 20: The method of any one of Clauses 1-19, wherein the NTN cell is supported by a satellite, wherein the satellite is in one of a GSO, a LEO or a MEO.

Clause 21: A method for wireless communications by a network entity, comprising: transmitting an indication that a NTN cell will stop broadcasting SS during a period of time; and performing one or more actions during the period of time based on the indication.

Clause 22: The method of Clause 21, wherein the one or more actions comprise ceasing transmissions in the NTN cell.

Clause 23: The method of Clause 22, wherein: the NTN cell comprises a GSO cell; and transmitting the indication comprises: transmitting a start time of the period of time in a first SIB; and transmitting an end time of the period of time and an identifier of the GSO cell in a second SIB.

Clause 24: The method of any one of Clauses 21-23, wherein the indication comprises: a start offset of a DTX cycle; a length of the DTX cycle; and a length of a DTX off period of the DTX cycle.

Clause 25: The method of any one of Clauses 21-24, wherein the indication comprises: a start time of a DTX off period of a DTX cycle; and an end time of the DTX off period.

Clause 26: The method of any one of Clauses 21-25, wherein transmitting the indication comprises transmitting the indication in a SIB, and the method further comprises: transmitting a paging indication indicating a change to the SIB.

Clause 27: The method of any one of Clauses 21-26, wherein transmitting the indication comprises transmitting information regarding a DTX cycle of the network entity, wherein the DTX cycle includes a DTX on period and a DTX off period, the method further comprising: transmitting new information regarding a new DTX cycle of the network entity during the DTX on period, wherein the new DTX cycle includes a new DTX on period and a new DTX off period; and updating a PSM or an eDRX cycle of a UE so that a PO for the UE occurs during the new DTX on period.

Clause 28: The method of Clause 27, wherein: the information regarding the DTX cycle comprises a length of the DTX cycle of the network entity.

Clause 29: The method of any one of Clauses 21-28, wherein transmitting the indication comprises transmitting information regarding a DTX cycle of the network entity, wherein the DTX cycle includes a DTX on period and a DTX off period, the method further comprising: obtaining an indication to page a UE during a PO during a paging preparation portion of the DTX on period; and deferring paging the UE until after the paging preparation portion of the DTX on period.

Clause 30: An apparatus, comprising: a memory comprising executable instructions; and a processor configured to execute the executable instructions and cause the apparatus to perform a method in accordance with any one of Clauses 1-29.

Clause 31: An apparatus, comprising means for performing a method in accordance with any one of Clauses 1-29.

Clause 32: A non-transitory computer-readable medium comprising executable instructions that, when executed by a processor of an apparatus, cause the apparatus to perform a method in accordance with any one of Clauses 1-29.

Clause 33: A computer program product embodied on a computer-readable storage medium comprising code for performing a method in accordance with any one of Clauses 1-29.

Clause 34: A method for wireless communications by a UE, comprising: receiving an indication that a NTN cell will stop broadcasting SS during a period of time; and refraining from performing all IDLE mode tasks during the period of time.

Clause 35: The method of Clause 34, further comprising refraining from communicating with the NTN cell.

Clause 36: The method of any one of Clauses 34 and 35, wherein: the NTN cell comprises a GSO cell; and receiving the indication comprises: receiving a start time of the period of time in a first SIB; and receiving an end time of the period of time and an identifier of the GSO cell in a second SIB.

Clause 37: The method of any one of Clauses 34-36, wherein receiving the indication comprises receiving information regarding a cell-specific DTX cycle of the NTN cell.

Clause 38: The method of Clause 37, wherein the information comprises: a start offset of the DTX cycle; a length of the DTX cycle; and a DTX off period of the DTX cycle.

Clause 39: The method of Clause 37, wherein the information comprises: a start time of a DTX off period of the DTX cycle; and an end time of the DTX off period.

Clause 40: The method of any one of Clauses 34-39, wherein the indication is received in a SIB, and the method further comprises: receiving a paging indication indicating a change to the SIB; and receiving the SIB in response to the paging indication.

Clause 41: The method of any one of Clauses 34-40, further comprising: after the period of time, searching for the cell for a default OFF period; and declaring a no cell available state in response to failing to detect the cell during the default OFF period

Clause 42: The method of Clause 41, wherein the default OFF period is defined in a communications specification.

Clause 43: The method of Clause 41, wherein: the indication comprises a length of a DTX cycle of the NTN cell; the default OFF period is determined as a fraction of the DTX cycle; and the fraction is defined in a communications specification.

Clause 44: The method of any one of Clauses 34-43, wherein the indication is received from another cell.

Clause 45: The method of Clause 44, wherein the indication is included in an inter-frequency list or a neighbor cell list.

Clause 46: The method of Clause 44, wherein the indication is received in a RRC release procedure.

Clause 47: The method of Clause 44, further comprising: measuring the NTN cell based on the indication.

Clause 48: The method of any one of Clauses 34-47, wherein the indication comprises at least one of a start time for the period of time, a duration of the period of time or a stop time for the period of time.

Clause 49: The method of any one of Clauses 34-48, wherein the NTN cell is supported by a satellite, wherein the satellite is in one of a GSO, a LEO or a MEO.

Clause 50: A method for wireless communications by a UE, comprising: receiving an indication that a NTN cell will stop broadcasting SS during a period of time; and in response to failing to detect a cell signal during a paging occasion (PO) during the period of time, refraining from performing a cell search during the period of time.

Clause 51: The method of Clause 50, wherein the one or more actions comprise refraining from communicating with the NTN cell.

Clause 52: The method of any one of Clauses 50 and 51, wherein: the NTN cell comprises a GSO cell; and receiving the indication comprises: receiving a start time of the period of time in a first SIB; and receiving an end time of the period of time and an identifier of the GSO cell in a second SIB.

Clause 53: The method of Clause 52, further comprising: performing one or more IDLE mode tasks during the period of time; and upon failing to detect the cell signal, refraining from performing at least one of intra-frequency, inter-frequency, or inter-RAT measurements, of a Terrestrial network cell, the NTN cell, or a non-GSO (NGSO) cell.

Clause 54: The method of any one of Clauses 50-53, further comprising: performing one or more IDLE mode tasks and attempting to detect the cell signal during the PO during the period of time.

Clause 55: The method of any one of Clauses 50-54, further comprising performing cell search during the period of time at least based on arrival of uplink data.

Clause 56: The method of any one of Clauses 50-55, wherein receiving the indication comprises receiving information regarding a cell-specific DTX cycle of the NTN cell.

Clause 57: The method of Clause 56, wherein the information comprises: a start offset of the DTX cycle; a length of the DTX cycle; and a DTX off period of the DTX cycle.

Clause 58: The method of Clause 56, wherein the information comprises: a start time of a DTX off period of the DTX cycle; and an end time of the DTX off period.

Clause 59: The method of any one of Clauses 50-58, wherein the indication is received in a SIB, and the method further comprises: receiving a paging indication indicating a change to the SIB; and receiving the SIB in response to the paging indication.

Clause 60: The method of any one of Clauses 50-59, further comprising: after the period of time, searching for the NTN cell for a default OFF period; and declaring a no cell available state in response to failing to detect the NTN cell during the default OFF period

Clause 61: The method of Clause 62, wherein the default OFF period is defined in a communications specification.

Clause 62: The method of Clause 60, wherein: the indication comprises a length of a DTX cycle of the NTN cell; the default OFF period is determined as a fraction of the DTX cycle; and the fraction is defined in a communications specification.

Clause 63: The method of any one of Clauses 50-62, wherein the indication is received from another cell.

Clause 64: The method of Clause 63, wherein the indication is included in an inter-frequency list or a neighbor cell list.

Clause 65: The method of Clause 63, wherein the indication is received in a RRC release procedure.

Clause 66: The method of Clause 63, further comprising: measuring the NTN cell based on the indication.

Clause 67: The method of any one of Clauses 50-66, wherein the indication comprises at least one of a start time for the period of time, a duration of the period of time or a stop time for the period of time.

Clause 68: The method of any one of Clauses 50-67, wherein the NTN cell is supported by a satellite, wherein the satellite is in one of a GSO, a LEO, or a MEO.

Clause 69: A method for wireless communications by a network entity, comprising: transmitting an indication that a NTN cell will stop broadcasting SS during a period of time; and ceasing one or more transmissions in the NTN cell during the period of time based on the indication.

Clause 70: The method of Clause 69, wherein: the NTN cell comprises a GSO cell; and transmitting the indication comprises: transmitting a start time of the period of time in a first SIB; and transmitting an end time of the period of time and an identifier of the GSO cell in a second SIB.

Clause 71: The method of any one of Clauses 69-70, wherein the indication comprises: a start offset of a DTX cycle; a length of the DTX cycle; and a length of a DTX off period of the DTX cycle.

Clause 72: The method of any one of Clauses 69-71, wherein the indication comprises: a start time of a DTX off period of a DTX cycle; and an end time of the DTX off period.

Clause 73: The method of any one of Clauses 69-72, wherein transmitting the indication comprises transmitting the indication in a SIB, and the method further comprises: transmitting a paging indication indicating a change to the SIB.

Clause 74: The method of any one of Clauses 69-73, wherein transmitting the indication comprises transmitting information regarding a DTX cycle of the network entity, wherein the DTX cycle includes a DTX on period and a DTX off period, the method further comprising: transmitting new information regarding a new DTX cycle of the network entity during the DTX on period, wherein the new DTX cycle includes a new DTX on period and a new DTX off period; and updating a PSM or an eDRX cycle of a UE so that a PO for the UE occurs during the new DTX on period.

Clause 75: The method of Clause 74, wherein: the information regarding the DTX cycle comprises a length of the DTX cycle of the network entity.

Clause 76: The method of any one of Clauses 69-75, wherein transmitting the indication comprises transmitting information regarding a DTX cycle of the network entity, wherein the DTX cycle includes a DTX on period and a DTX off period, the method further comprising: obtaining an indication to page a UE during a PO during a paging preparation portion of the DTX on period; and deferring paging the UE until after the paging preparation portion of the DTX on period.

Clause 77: An apparatus, comprising: a memory comprising executable instructions; and a processor configured to execute the executable instructions and cause the apparatus to perform a method in accordance with any one of Clauses 34-76.

Clause 78: An apparatus, comprising means for performing a method in accordance with any one of Clauses 34-76.

Clause 79: A non-transitory computer-readable medium comprising executable instructions that, when executed by a processor of an apparatus, cause the apparatus to perform a method in accordance with any one of Clauses 34-76.

Clause 80: A computer program product embodied on a computer-readable storage medium comprising code for performing a method in accordance with any one of Clauses 34-76.

Clause 81: An apparatus for wireless communication at a user equipment (UE), comprising: a processing system that includes processor circuitry and memory circuitry that stores code and is coupled with the processor circuitry, the processing system configured to cause the UE to perform the method of one or more of Clauses 1-20.

Clause 82: An apparatus for wireless communication at a user equipment (UE), comprising: a processing system that includes processor circuitry and memory circuitry that stores code and is coupled with the processor circuitry, the processing system configured to cause the UE to perform the method of one or more of Clauses 34-68.

Clause 83: An apparatus for wireless communication at a network entity, comprising: a processing system that includes processor circuitry and memory circuitry that stores code and is coupled with the processor circuitry, the processing system configured to cause the network entity to perform the method of one or more of Clauses 69-76.

Clause 84: An apparatus for wireless communication at a user equipment (UE), comprising: one or more memories; and one or more processors coupled with the one or more memories and configured to cause the UE to perform the method of one or more of Clauses 1-20.

Clause 85: An apparatus for wireless communication at a network entity, comprising: one or more memories; and one or more processors coupled with the one or more memories and configured to cause the network entity to perform the method of one or more of Clauses 21-29.

Clause 86: An apparatus for wireless communication at a user equipment (UE), comprising: one or more memories; and one or more processors coupled with the one or more memories and configured to cause the UE to perform the method of one or more of Clauses 34-68.

Clause 87: An apparatus for wireless communication at a network entity, comprising: one or more memories; and one or more processors coupled with the one or more memories and configured to cause the network entity to perform the method of one or more of Clauses 69-76.

Clause 88: An apparatus for wireless communication at a user equipment (UE), comprising: one or more memories; and one or more processors coupled with the one or more memories and configured to individually or collectively cause the UE to perform the method of one or more of Clauses 1-20.

Clause 89: An apparatus for wireless communication at a network entity, comprising: one or more memories; and one or more processors coupled with the one or more memories and configured to individually or collectively cause the network entity to perform the method of one or more of Clauses 21-29.

Clause 90: An apparatus for wireless communication at a user equipment (UE), comprising: one or more memories; and one or more processors coupled with the one or more memories and configured to individually or collectively cause the UE to perform the method of one or more of Clauses 34-68.

Clause 91: An apparatus for wireless communication at a network entity, comprising: one or more memories; and one or more processors coupled with the one or more memories and configured to individually or collectively cause the network entity to perform the method of one or more of Clauses 69-76.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions, or multiple memories configured to collectively store data and/or instructions.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communications at a user equipment (UE), comprising:
one or more memories; and
one or more processors coupled with the one or more memories and configured to cause the UE to:
receive an indication that a non-terrestrial network (NTN) cell will stop broadcasting synchronization signals (SS) during a period of time; and
refrain from performing all IDLE mode tasks during the period of time.

2. The apparatus of claim 1, wherein the one or more processors are further configured to cause the UE to refrain from communicating with the NTN cell.

3. The apparatus of claim 1, wherein:
the NTN cell comprises a geosynchronous orbit (GSO) cell; and
to cause the UE to receive the indication, the one or more processors are configured to cause the UE to:
receive a start time of the period of time in a first system information block (SIB); and
receive an end time of the period of time and an identifier of the GSO cell in a second SIB.

4. The apparatus of claim 1, wherein to cause the UE to receive the indication, the one or more processors are configured to cause the UE to receive information regarding a cell-specific discontinuous transmission (DTX) cycle of the NTN cell.

5. The apparatus of claim 4, wherein the information comprises:
a start offset of the DTX cycle;
a length of the DTX cycle; and
a DTX off period of the DTX cycle.

6. The apparatus of claim 4, wherein the information comprises:
a start time of a DTX off period of the DTX cycle; and
an end time of the DTX off period.

7. The apparatus of claim 1, wherein to cause the UE to receive the indication, the one or more processors are configured to cause the UE to receive the indication in a system information block (SIB), and wherein the one or more processors are further configured to cause the UE to:
receive a paging indication that indicates a change to the SIB; and
receive the SIB in response to the paging indication.

8. The apparatus of claim 1, wherein the one or more processors are further configured to cause the UE to:
after the period of time, search for the cell for a default OFF period; and
declare a no cell available state in response to failing to detect the cell during the default OFF period.

9. The apparatus of claim 8, wherein:
the indication comprises a length of a discontinuous transmission (DTX) cycle of the NTN cell; and
the default OFF period is determined as a fraction of the DTX cycle.

10. The apparatus of claim 1, wherein to cause the UE to receive the indication, the one or more processors are configured to cause the UE to receive the indication from another cell.

11. The apparatus of claim 10, wherein the indication is at least one of:
included in an inter-frequency list or a neighbor cell list; or
received in a radio resource control (RRC) release procedure.

12. The apparatus of claim 10, wherein the one or more processors are further configured to cause the UE to:
measure the NTN cell based on the indication.

13. The apparatus of claim 1, wherein the indication comprises at least one of a start time for the period of time, a duration of the period of time, or a stop time for the period of time.

14. The apparatus of claim 1, wherein the NTN cell is supported by a satellite, wherein the satellite is in one of a geosynchronous orbit (GSO), a low Earth orbit (LEO), or a medium Earth orbit (MEO).

15. An apparatus for wireless communications at a user equipment (UE), comprising:
one or more memories; and
one or more processors coupled with the one or more memories and configured to cause the UE to:
receive an indication that a non-terrestrial network (NTN) cell will stop broadcasting synchronization signals (SS) during a period of time; and
in response to failing to detect a cell signal during a paging occasion (PO) during the period of time, refrain from performing a cell search during the period of time.

16. The apparatus of claim 15, wherein the one or more processors are further configured to cause the UE to refrain from communicating with the NTN cell.

17. The apparatus of claim 15, wherein:
the NTN cell comprises a geosynchronous orbit (GSO) cell; and
to cause the UE to receive the indication, the one or more processors are configured to cause the UE to:
receive a start time of the period of time in a first system information block (SIB); and
receive an end time of the period of time and an identifier of the GSO cell in a second SIB.

18. The apparatus of claim 17, wherein the one or more processors are further configured to cause the UE to:
perform one or more IDLE mode tasks during the period of time; and
upon failing to detect the cell signal, refrain from performing at least one of intra-frequency, inter-frequency, or inter-radio access technology (inter-RAT) measurements, of a Terrestrial network cell, the NTN cell, or a non-GSO (NGSO) cell.

19. The apparatus of claim 15, wherein the one or more processors are further configured to cause the UE to:
perform one or more IDLE mode tasks and attempt to detect the cell signal during the PO during the period of time.

20. The apparatus of claim 15, wherein the one or more processors are further configured to cause the UE to perform cell search during the period of time at least based on arrival of uplink data.

21. The apparatus of claim 15, wherein to cause the UE to receive the indication, the one or more processors are configured to cause the UE to receive information regarding a cell-specific discontinuous transmission (DTX) cycle of the NTN cell.

22. The apparatus of claim 21, wherein the information comprises:
a start offset of the DTX cycle;
a length of the DTX cycle; and
a DTX off period of the DTX cycle.

23. The apparatus of claim 21, wherein the information comprises:
a start time of a DTX off period of the DTX cycle; and
an end time of the DTX off period.

24. The apparatus of claim 15, wherein to cause the UE to receive the indication, the one or more processors are configured to cause the UE to receive the indication in a system information block (SIB), and the one or more processors are further configured to cause the UE to:
receive a paging indication that indicates a change to the SIB; and
receive the SIB in response to the paging indication.

25. The apparatus of claim 15, wherein the one or more processors are further configured to cause the UE to:
after the period of time, search for the NTN cell for a default OFF period; and
declare a no cell available state in response to failing to detect the NTN cell during the default OFF period.

26. The apparatus of claim 25, wherein:
the indication comprises a length of a discontinuous transmission (DTX) cycle of the NTN cell; and
the default OFF period is determined as a fraction of the DTX cycle.

27. The apparatus of claim 15, wherein to cause the UE to receive the indication, the one or more processors are configured to cause the UE to receive the indication from another cell.

28. The apparatus of claim 27, wherein the indication is at least one of:
included in an inter-frequency list or a neighbor cell list; or
received in a radio resource control (RRC) release procedure.

29. The apparatus of claim 27, wherein the one or more processors are further configured to cause the UE to:
measure the NTN cell based on the indication.

30. The apparatus of claim 15, wherein the indication comprises at least one of a start time for the period of time, a duration of the period of time, or a stop time for the period of time.

31. The apparatus of claim 15, wherein the NTN cell is supported by a satellite, wherein the satellite is in one of a geosynchronous orbit (GSO), a low Earth orbit (LEO), or a medium Earth orbit (MEO).

32. An apparatus for wireless communications at a network entity, comprising:
one or more memories; and
one or more processors coupled with the one or more memories and configured to cause the network entity to:
transmit an indication that a non-terrestrial network (NTN) cell will stop broadcasting synchronization signals (SS) during a period of time; and
cease one or more transmissions in the NTN cell during the period of time based on the indication.

33. The apparatus of claim 32, wherein:
the NTN cell comprises a geosynchronous satellite orbit (GSO) cell; and
to transmit the indication, the one or more processors are configured to cause the network entity to:
transmit a start time of the period of time in a first system information block (SIB); and
transmit an end time of the period of time and an identifier of the GSO cell in a second SIB.

34. The apparatus of claim 32, wherein to cause the network entity to transmit the indication, the one or more processors are configured to cause the network entity to transmit information regarding a discontinuous transmission (DTX) cycle of the network entity, wherein the DTX cycle includes a DTX on period and a DTX off period, and the one or more processors are further configured to cause the network entity to:
transmit new information regarding a new DTX cycle of the network entity during the DTX on period, wherein the new DTX cycle includes a new DTX on period and a new DTX off period; and
update a power saving mode (PSM) or an extended discontinuous reception (eDRX) cycle of a user equipment (UE) so that a paging occasion (PO) for the UE occurs during the new DTX on period.

35. The apparatus of claim 32, wherein to cause the network entity to transmit the indication, the one or more processors are configured to cause the network entity to transmit information regarding a discontinuous transmission (DTX) cycle of the network entity, wherein the DTX cycle includes a DTX on period and a DTX off period, and the one or more processors are further configured to cause the network entity to:
obtain an indication to page a user equipment (UE) during a paging occasion (PO) during a paging preparation portion of the DTX on period; and
defer paging the UE until after the paging preparation portion of the DTX on period.
